(19) United States
(12) Patent Application Publication
(10) Pub. No.: US 2019/0090037 A1
(43) Pub. Date: Mar. 21, 2019

(54) OPTICAL TRANSMISSION APPARATUS, SYSTEM, AND METHOD

(71) Applicant: FUJITSU LIMITED, Kawasaki-shi (JP)

(72) Inventor: Masao Nakata, Kawasaki (JP)

(73) Assignee: FUJITSU LIMITED, Kawasaki-shi (JP)

(21) Appl. No.: 16/129,271

(22) Filed: Sep. 12, 2018

(30) Foreign Application Priority Data
Sep. 19, 2017 (JP) 2017-179501

(51) Int. Cl. H04Q 11/00

(52) U.S. Cl. CPC H04Q 11/0005; H04Q 2011/0015; H04Q 2011/0016

(57) ABSTRACT

An optical transmission apparatus for transmitting a main signal, the optical transmission apparatus being arranged on an optical transmission line, the optical transmission apparatus includes a first processor configured to perform alarm supervision and signal control of the optical transmission apparatus; a second processor configured to perform the alarm supervision and the signal control of the optical transmission apparatus during a period when the first processor is in a stopped state; inter-apparatus transmitter and receivers configured to transmit and receive a signal including control information for the alarm supervision between the first and second processors and another optical transmission apparatus facing the optical transmission apparatus; and a multiplexer and demultiplexer configured to couple and split the signal for the main signal optically communicated with the another optical transmission apparatus.

### CROSS-REFERENCE TO RELATED APPLICATION

This application is based upon and claims the benefit of priority of the prior Japanese Patent Application No. 2017-179501, filed on Sep. 19, 2017, the entire contents of which are incorporated herein by reference.

### FIELD

The embodiments discussed herein are related to an optical transmission apparatus, an optical transmission system, and an optical transmission method for supervising a light signal to be transmitted using a supervisory control signal.

### BACKGROUND

There is a growing demand for an optical transmission system with an apparatus configuration high in degree of route freedom which allows connection of a path for WDM signal light to a large number of routes among WDM optical transmission systems, to which wavelength division multiplexing (WDM) transmission is applied. The apparatus configuration enhances the flexibility of network construction and allows adoption of a large number of redundant paths. An optical transmission apparatus high in degree of route freedom has an optical add-drop multiplexer (OADM) function of adding or dropping WDM signal light in an arbitrary direction and a CD function capable of arbitrarily setting wavelength assignment and a route for a WDM signal and serving as an optical cross-connect (OXC).

WDM stands for wavelength division multiplexing. OADM stands for optical add-drop multiplexer. OXC stands for optical cross-connect, and CD stands for colorless-directionless.

A wavelength division multiplexing type optical transmission system employs an in-band supervision method using same optical transmission lines for a WDM signal and a supervisory signal (an optical supervisory channel (OSC)). In the in-band supervision method, a fault in an optical transmission line affects a supervisory control network. For higher network reliability, a configuration with redundant supervisory control routes is adopted for a network in which optical transmission apparatuses are connected in a ring. If a network of an optical transmission system is not a ring-shaped network, redundant supervisory control routes are hard to provide for a network. For example, if a supervisory control function of an optical transmission apparatus stops in the above-described non-ring-shaped network, a network management apparatus (NMS) is incapable of supervisory control of optical transmission apparatuses more remote than an optical transmission apparatus and optical transmission lines between the optical transmission apparatuses. NMS stands for network management system.

As a conventional technique for overcoming the problem, a technique including a multilayer inter-apparatus communication unit between an optical transmission apparatus (L0 apparatus) in a WDM signal layer (L0) and a communication apparatus (Lx apparatus) in a layer (Lx) different from L0 is disclosed (see Japanese Laid-open Patent Publication No. 2015-204467 hereinafter referred to as patent literature 1). In the technique, a supervisory control network for an L0 network and a supervisory control network for an Lx network complement each other by using a supervisory control signal for an Lx apparatus. If a fault that is a partial interruption of a supervisory control network for a network in a given layer occurs, supervisory control information for the layer with the fault is transmitted and received to and from an NMS using a supervisory control network for a different layer. This allows speedy maintenance operation and implements enhancement in supervisory control network reliability.

However, the supervisory control network for the Lx network uses a WDM signal for an optical transmission apparatus, that is, uses the L0 network as an Lx supervisory control network to transmit and receive supervisory control information to and from the Lx apparatus at a remote site. For this reason, if a fault occurs in the L0 network, the supervisory control networks do not complement each other, and there is an interruption at a location of the fault.

For example, if a fault occurs in a WDM signal path set at a site more remote than an optical transmission apparatus when a supervisory control function of the optical transmission apparatus in the supervisory control network for the L0 network is in a stopped state, the supervisory control networks for both the L0 network and the Lx network are shut down. This disables collection of fault information from the supervisory control networks and identification of a location of the fault in the WDM signal path. Since the L0 and Lx supervisory control networks between the NMS and the optical transmission apparatus are shut down, the network fault continues for a long period of time without switching control of a detour WDM signal path for recovery from the fault, and identification of the location of the fault is hard. For this reason, recovery from the fault takes great effort, which causes a problem with network maintenance.

Since each supervisory control network is a supervisory control network which performs multilayer inter-apparatus communication for adding, to supervisory control information for a given layer, supervisory control information for a different layer, a control interface across apparatuses in different layers and a frame format of supervisory control information for each layer are complicated. Additionally, in an optical transmission network in which apparatuses in different layers are not stored at a same site, a complementary supervisory control network may not be constructed. For this reason, an optical transmission network is desired to be a large-scale and expensive network in which apparatuses in different layers are installed at a same site. In light of the above-described circumstances, supervisory control using supervisory control information is desirably continued even in the event of a fault inside and outside an apparatus.

### SUMMARY

According to an aspect of the invention, an optical transmission apparatus for transmitting a main signal, the optical transmission apparatus being arranged on an optical transmission line, the optical transmission apparatus includes a first processor configured to perform alarm supervision and signal control of the optical transmission apparatus; a second processor configured to perform the alarm supervision and the signal control of the optical transmission apparatus during a period when the first processor is in a stopped state; inter-apparatus transmitter and receivers configured to transmit and receive a signal including control information for the alarm supervision between the first and second processors and another optical transmission apparatus facing the optical transmission apparatus; and a multiplexer and demultiplexer configured to couple and split the signal for the main signal optically communicated with the another optical transmission apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a common WDM optical transmission system;

FIG. 2 is a diagram (part I) for explaining network supervisory control according to an existing technique;

FIG. 3 is a diagram (part II) for explaining the network supervisory control according to the existing technique;

FIG. 4 is a diagram illustrating a state in which supervisory control network complementation does not work after a supervision function of an L0 apparatus supervisory control unit in an existing optical transmission apparatus stops;

FIG. 5 is a diagram illustrating an example of a configuration of an optical transmission system including an optical transmission apparatus according to a first embodiment;

FIG. 6 is a diagram illustrating an example of a hardware configuration of redundant supervisory control units of the optical transmission apparatus according to the first embodiment;

FIG. 7 is a chart illustrating an example of supervisory control information in an LCN signal packet used by the optical transmission apparatus according to the first embodiment;

FIG. 8 is a flowchart illustrating an example of supervisory control to be performed by a second supervisory control unit of the optical transmission apparatus according to the first embodiment;

FIG. 9 is a flowchart illustrating an example of supervisory control to be performed by a first supervisory control unit of the optical transmission apparatus according to the first embodiment;

FIG. 10 is a sequence chart illustrating a redundant supervisory control switching process by the optical transmission apparatus according to the first embodiment;

FIG. 11A is a diagram (part I) for explaining a state in which supervisory control is continuing in the event of a plurality of faults in the optical transmission system using the optical transmission apparatus according to the first embodiment;

FIG. 11B is a diagram (part II) for explaining the state in which the supervisory control is continuing in the event of the plurality of faults in the optical transmission system using the optical transmission apparatus according to the first embodiment;

FIG. 12 is a diagram illustrating an example of a configuration of an optical transmission apparatus according to a second embodiment;

FIG. 13 is a diagram illustrating an example of a hardware configuration of redundant supervisory control units of the optical transmission apparatus according to the second embodiment;

FIG. 14 is a flowchart illustrating an example of supervisory control to be performed by a first supervisory control unit of the optical transmission apparatus according to the second embodiment;

FIG. 15 is a flowchart illustrating an example of supervisory control to be performed by a second supervisory control unit of the optical transmission apparatus according to the second embodiment;

FIG. 16 is a sequence chart illustrating a redundant supervisory control switching process by the optical transmission apparatus according to the second embodiment; and

FIG. 17 is a diagram illustrating an example of a configuration of a different optical transmission apparatus according to the second embodiment.

### DESCRIPTION OF EMBODIMENTS

Functions of and problems with a conventional optical transmission system will be described first. A WDM optical transmission apparatus, to which WDM transmission is applied, has the above-described OADM function, and a wavelength selective switch (WSS) is used for the OADM function. The WSS allows arbitrary setting of a WDM signal path for each wavelength. At a location of connection between the OADM function and an optical transmission line, an optical amplification (AMP) function of amplifying a WDM signal to be outputted to the optical transmission line or inputted from the optical transmission line to an appropriate light level is provided to compensate for an optical loss in a WDM signal caused by the OADM function.

A multiplexer and demultiplexer or a WSS capable of inputting and outputting a WDM signal of an arbitrary wavelength from and to a desired route is used for the above-described CD function serving as an OXC. This allows setting of a path for a WDM signal of an arbitrary wavelength to be connected to the OADM function to an arbitrary direction without connection switching.

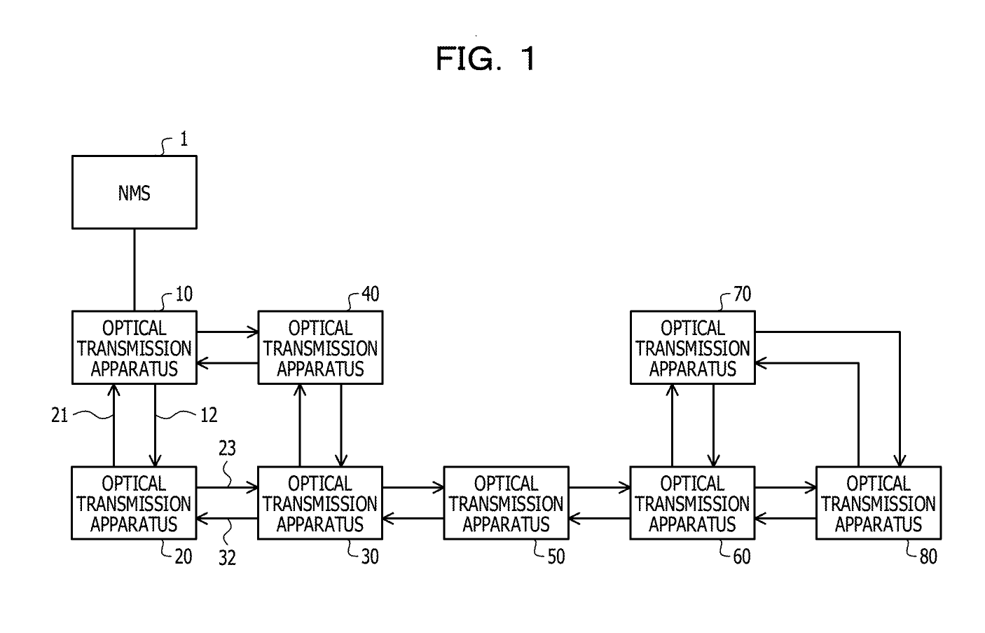

FIG. 1 is a diagram illustrating an example of a configuration of a common WDM optical transmission system. In the optical transmission system illustrated in FIG. 1, a network management apparatus (NMS) 1 performs network supervision on a plurality of optical transmission apparatuses 10 to 80 using an OSC.

The optical transmission apparatus 10 is connected to the optical transmission apparatus 20 that is arranged at an adjacent remote site via a downbound optical transmission line 12 and an upbound optical transmission line 21. The optical transmission apparatus 20 connects with the optical transmission apparatus 30 in a route different from a route to the optical transmission apparatus 10 via downbound and upbound optical transmission lines 23 and 32. In this manner, an optical transmission system over a WDM signal line from the optical transmission apparatus 10 to the optical transmission apparatus 30 is constructed. Connection between optical transmission apparatuses via optical transmission lines is configured in the same manner for the optical transmission apparatuses 10 to 80, and a network for a long-range optical transmission system is constructed.

In the optical transmission system in FIG. 1, line supervision and path setting control for the optical transmission system are performed using the NMS 1 in order to establish a new normal path at the time of setting a WDM signal path and in the event of an optical transmission line fault, and optical transmission apparatuses arranged at remote sites and network lines of the optical transmission system are supervised using an OSC function. The NMS 1 is connected to the optical transmission apparatus 10 that is a gateway apparatus of the optical transmission system, and collects fault statuses of the optical transmission system connected to the optical transmission apparatus 10 and performs path setting control, such as WDM signal path switching, on the optical transmission system.

The NMS 1 supervises the optical transmission apparatuses 20 to 80 arranged at sites remote from the optical transmission apparatus 10 serving as a gateway and the network lines of the optical transmission system. At this time, the NMS 1 supervises WDM signal lines using an OSC signal, through which supervisory control information is transmitted and received between optical transmission apparatuses via same (in-band) optical transmission lines as those for the WDM signal lines, and a supervisory control function responsible for supervisory control in each optical transmission apparatus.

For a wavelength division multiplexing type optical transmission system, there is available an out-of-band supervisory control method, in which a WDM signal and an OSC signal use different optical transmission lines. In the out-of-band method, if a fault that is a WDM signal interruption occurs and an OSC signal is normal, it is unclear whether a WDM signal interruption has occurred due to coming-off of an output of an AMP function from an optical transmission line or a WDM signal has zero waves under normal connection. This impairs the reliability of supervision of WDM signal lines. A multiwavelength WDM signal is optically amplified by the AMP function, and a high level of light is output to an optical transmission line. For this reason, an automatic power shutdown (APSD) control function is provided for safety such that a high level of light is not output if the output of the AMP function comes off from an optical transmission line. Thus, high reliability is desired for supervision of WDM signal lines. For the above-described reason, a wavelength division multiplexing type optical transmission system uses an in-band supervision method in which same optical transmission lines are used for a WDM signal and an OSC signal.

Note that, in the in-band supervision method in the optical transmission system, a fault in an optical transmission line affects a supervisory control network. For this reason, a configuration in which network reliability is enhanced by providing redundant supervisory control routes using a ring-shaped network as indicated by the optical transmission apparatuses 10 to 40 is adopted. Provision of redundant supervisory control routes allows detouring around an obstructed supervisory control route and performing network supervisory control even in a case where a supervisory control function of an optical transmission apparatus is in a stopped state due to software update or a fault and recovery from the fault.

Examples of a fault in a supervisory control function include software restarting due to exception processing and a soft error fault. For example, even if a supervisory control function of the optical transmission apparatus 20 in the optical transmission system in FIG. 1 stops due to software update or a fault as described above, supervisory control of the optical transmission apparatus 30 and the optical transmission apparatuses 50 to 80 remote from the optical transmission apparatus 30 is possible via the optical transmission apparatus 40.

If the optical transmission system has a non-ring-shaped network as indicated by the optical transmission apparatus 30 and the optical transmission apparatuses 50 to 80 remote from the optical transmission apparatus 30, provision of redundant supervisory control routes for the network is hard. For example, if a supervisory control function of the optical transmission apparatus 30 stops in the non-ring-shaped network, the NMS 1 is incapable of supervisory control of the optical transmission apparatuses 50 to 80 more remote than the optical transmission apparatus 30 and optical transmission lines between the optical transmission apparatuses.

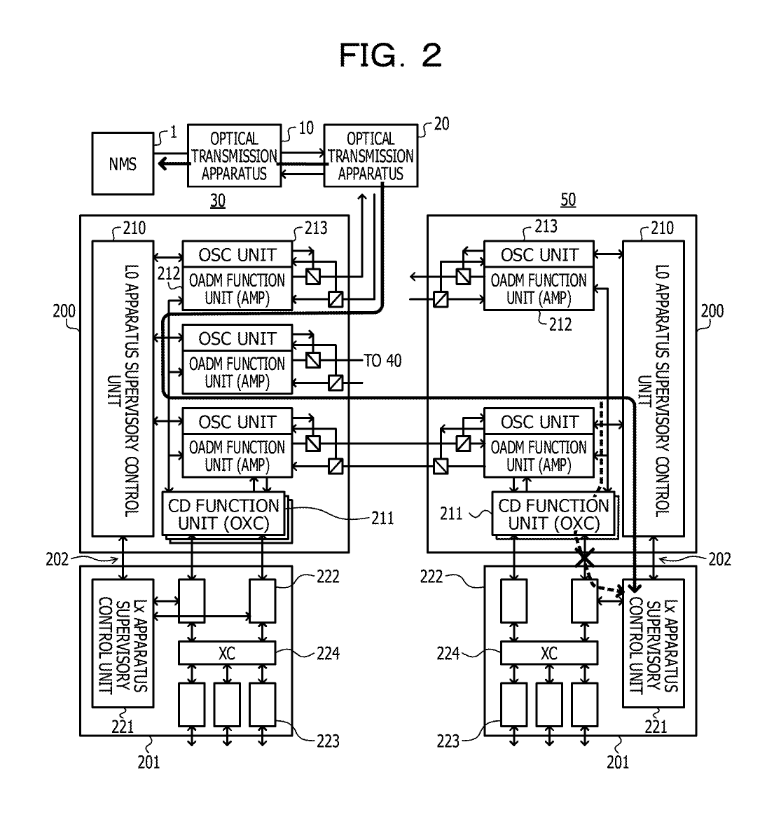

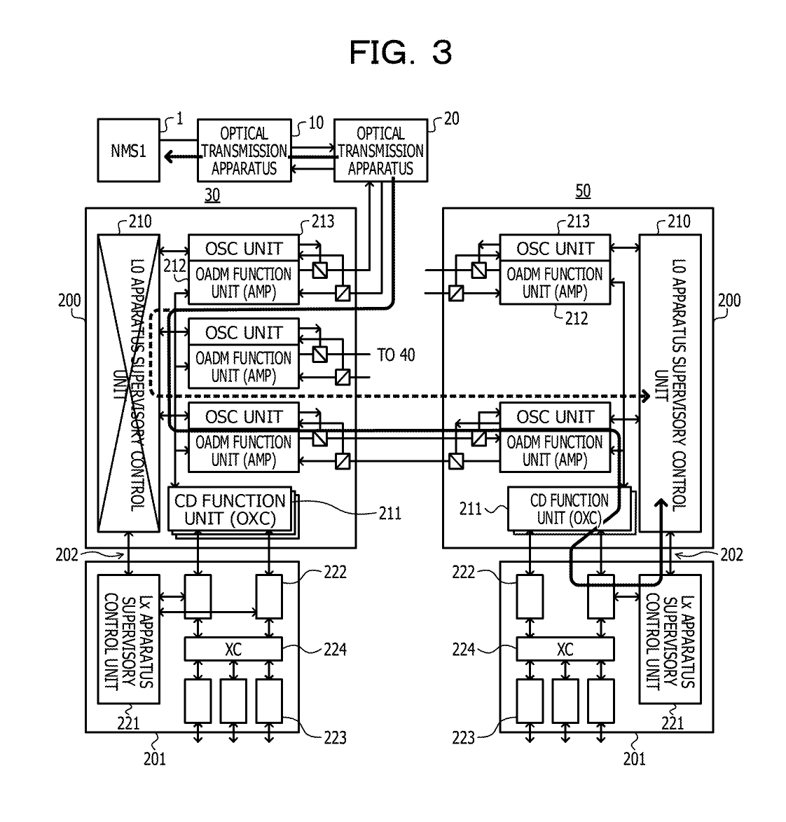

FIGS. 2 and 3 are diagrams for explaining network supervisory control according to an existing technique. FIGS. 2 and 3 mainly illustrate internal configurations of some optical transmission apparatuses, the optical transmission apparatuses 30 and 50. For example, according to the technique disclosed in patent literature 1 described above, each of the optical transmission apparatuses 10 to 80 includes an optical transmission apparatus (L0 apparatus) 200 in a WDM signal layer (L0) and a multilayer inter-apparatus communication unit 202 for a communication apparatus (Lx apparatus) 201 in a layer (Lx; x=1, 2, . . . ) different from L0. With use of a supervisory control signal for the Lx apparatus, a supervisory control network for an L0 network and a supervisory control network for an Lx network complement and supervise each other. The L0 apparatus 200 is an apparatus of a trunk system, such as an infrastructure, and performs high-speed communication. The Lx apparatus 201 is a user-side apparatus and performs low- to medium-speed communication.

The L0 apparatus 200 includes an L0 apparatus supervisory control unit 210, a CD function unit 211, a plurality of OADM function units 212, and a plurality of OSC units 213. The Lx apparatus 201 includes an Lx apparatus supervisory control unit 221, a transponder unit 222, a client signal transmission and reception unit 223, and an XC unit 224.

According to the conventional technique, when a supervisory control network fault (a location X in FIG. 2) occurs in the Lx network at the optical transmission apparatus 50, the optical transmission apparatus 50 adds information on the location X of fault in the Lx network to L0 supervisory control information and communicates the L0 supervisory control information to the NMS 1 (a route indicated by a solid line in FIG. 2) by the use of the supervisory control network for the L0 network without any fault and the multilayer inter-apparatus communication unit 202. With the communication, the NMS 1 is capable of identifying the location X of fault in the Lx network, performing path switching to bypass the location X of fault, and constructing a supervisory control network with reliability and maintainability.

FIG. 3 illustrates a state in which a supervisory control network is complemented when a supervision function of the L0 apparatus supervisory control unit 210 of the optical transmission apparatus 30 illustrated in FIG. 2 is in the stopped state. As illustrated in FIG. 3, even if the L0 supervision function in the L0 apparatus supervisory control unit 210 of the optical transmission apparatus 30 stops due to a failure or the like, the supervisory control network for the Lx network is capable of complementing the supervisory control network of for the L0 network. It is thus possible to transmit and receive supervisory control information to and from an optical transmission apparatus more remote than the optical transmission apparatus 50.

At this time, a route indicated by a dotted line in FIG. 3 which passes through the L0 apparatus supervisory control unit 210 of the optical transmission apparatus 30 is impassable. However, a route indicated by a solid line in FIG. 3 connects the OADM function units 212 without passing through the L0 apparatus supervisory control unit 210 inside the optical transmission apparatus 30. Inside the optical transmission apparatus 50, the route passes through the OADM function unit 212, the CD function unit 211, the multilayer inter-apparatus communication unit 202, the transponder unit 222 of the Lx apparatus 201, the multilayer inter-apparatus communication unit 202, and the Lx apparatus supervisory control unit 221 and connects with the L0 apparatus supervisory control unit 210 of the L0 apparatus 200. In this case, no OSC is used, supervisory control information is superimposed on an Lx WDM signal (main signal), and the Lx WDM signal is transmitted.

As described above, if a fault that is a partial interruption of a supervisory control network for a network in a given layer occurs, supervisory control information for the layer with the fault is transmitted and received to and from the NMS 1 using a supervisory control network for a different layer. This allows speedy maintenance operation and achieves enhancement in supervisory control network reliability.

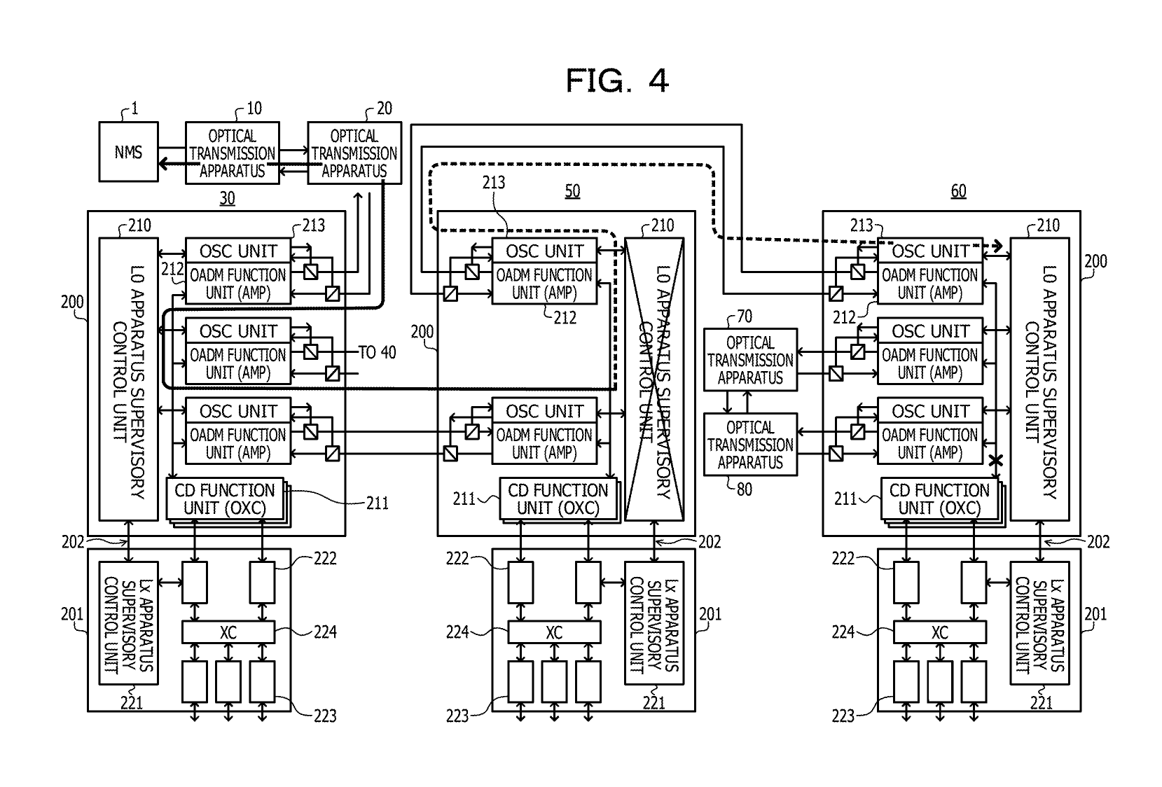

FIG. 4 is a diagram illustrating a state in which supervisory control network complementation does not work after a supervision function of an L0 apparatus supervisory control unit in an existing optical transmission apparatus stops. Assume that a fault occurs in a set WDM signal path at a site (a location X) more remote than the optical transmission apparatus 50 when the L0 apparatus supervisory control unit 210 of the optical transmission apparatus 50 in the supervisory control network for the L0 network is in the stopped state. In this case, the supervisory control networks for both the L0 network and the Lx network are shut down (a route indicated by a solid line is connected and active, but a route indicated by a dotted line is impassable). This disables the NMS 1 to collect fault information from the supervisory control networks downstream of the optical transmission apparatus 50 and to identify the location of the fault in the WDM signal path. In this case, the optical transmission apparatus 50 is not located on a ring network and is incapable of path switching to a different optical transmission apparatus and path switching through detouring.

As for the case of the above-described fault, stoppage of supervision of the L0 network occurs, for example, at the time of resetting associated with software update of the L0 apparatus supervisory control unit 210, in the event of a software error, or at the time of restarting associated with memory resetting monthly or the like.

In the event of the fault in FIG. 4, the L0 and Lx supervisory control networks between the NMS 1 and the optical transmission apparatus 50 are shut down. For this reason, the network fault continues for a long period of time without switching control of a detour WDM signal path for recovery from the fault. Additionally, since identification of the location of the fault is hard, recovery from the fault takes great effort, which causes a problem with network maintenance.

As described above, the configuration according to the conventional technique (patent literature 1) employs a supervisory control network including a multilayer inter-apparatus communication unit for adding, to supervisory control information for a given layer, supervisory control information for a different layer. For this reason, a control interface across apparatuses in different layers and a frame format of supervisory control information for each layer are complicated. Additionally, since a complementary supervisory control network may not be constructed in an optical transmission network in which apparatuses in different layers are not stored at a same site, an optical transmission network is desired to be a large-scale and expensive network in which apparatuses in different layers are installed at a same site.

### First Embodiment

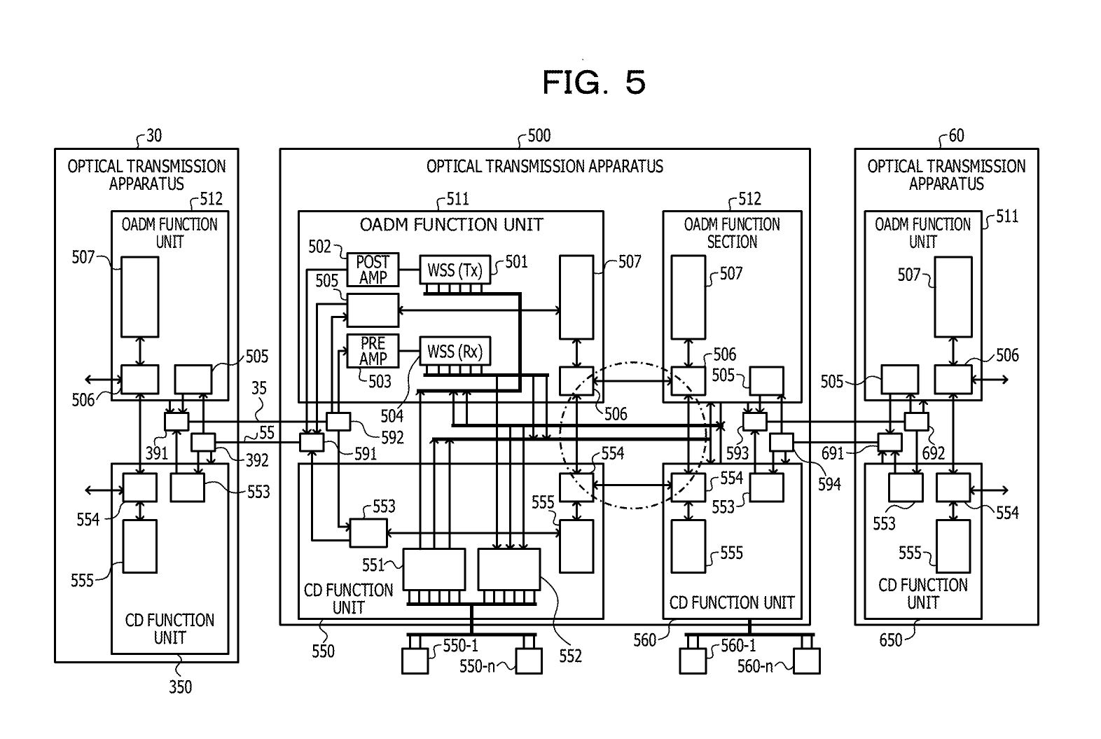

FIG. 5 is a diagram illustrating an example of a configuration of an optical transmission system including an optical transmission apparatus according to a first embodiment. The optical transmission system according to the present disclosure illustrated in FIG. 5 has a same network configuration as that in FIG. 1. An optical transmission apparatus 500 corresponds to the optical transmission apparatus 50 in FIG. 1, is arranged more remote from an NMS 1 (see FIG. 1) than an optical transmission apparatus 30, and is not included in a ring network. Although an internal configuration of only the optical transmission apparatus 500 is illustrated in detail in FIG. 5, other optical transmission apparatuses 30 and 60 have same internal configurations as that of the optical transmission apparatus 500.

The optical transmission apparatus 500 has a function of adding a WDM signal (main signal) to the optical transmission network and a function of dropping a WDM signal from the network. The optical transmission apparatus 500 includes CD function units 550 and 560 which optically cross-connect transponder units housed for WDM signals of respective wavelengths to OADM function units 511 and 512 as transmission devices in addition to the OADM function units 511 and 512. In FIG. 5, some functions of each of the OADM function unit 512 and the CD function unit 560 are not illustrated. The OADM function units 511 and 512, however, have same internal configurations, and the CD function units 550 and 560 have same internal configurations.

The OADM function unit 511 includes a transmission WSS 501, a post-amplifier (AMP) 502, a pre-AMP 503, a reception WSS 504, a first OSC transmission and reception unit 505, a first LCN transmission and reception unit 506, and a first supervisory control unit 507. LCN stands for local communication network.

In the first embodiment, LCN transmission and reception units 506 and 554 of function units (the OADM function units 511 and 512 and the CD function units 550 and 560) inside the optical transmission apparatus 500 function as supervisory signal transmission and reception units and transmit and receive a supervisory signal using an LCN inside the optical transmission apparatus 500. The first supervisory control unit 507 is provided at the OADM function unit 511, and a second supervisory control unit 555 is provided at the CD function unit 550. The first supervisory control unit 507 and the second supervisory control unit 555 transmit and receive supervisory control information to and from the optical transmission apparatus 30 on the upstream side. The first supervisory control unit 507 is provided at the OADM function unit 512, and the second supervisory control unit 555 is provided at the CD function unit 560. The first supervisory control unit 507 and the second supervisory control unit 555 transmit and receive supervisory control information to and from the optical transmission apparatus 60 on the downstream side.

The transmission WSS 501 wavelength-division-multiplexes WDM signals output from a large number of routes of the OADM function unit 512 and the CD function unit 550 and outputs the wavelength-division-multiplexed WDM signal to the post-AMP 502. The post-AMP 502 collectively and optically amplifies the WDM signal wavelength-division-multiplexed by the transmission WSS 501 and outputs the optically-amplified WDM signal to an optical transmission line. The pre-AMP 503 collectively and optically amplifies a WDM signal input from an optical transmission line. The reception WSS 504 distributes the WDM signal optically amplified by the pre-AMP 503 to a large number of routes.

The first OSC transmission and reception unit 505 functions as an inter-apparatus supervisory signal transmission and reception unit which transmits and receives a supervisory control signal to and from the adjacent optical transmission apparatus 30 via optical transmission lines. The first LCN transmission and reception unit 506 transmits and receives supervisory control information to and from each function unit inside the optical transmission apparatus 500 using an LCN signal. The first supervisory control unit 507 is responsible for I/O control of supervisory control information based on an LCN signal inside the optical transmission apparatus 500 and supervisory control information based on an OSC signal between the optical transmission apparatus 500 and the optical transmission apparatus 30.

The OADM function unit 511 is connected to the optical transmission apparatus 30 via an upbound optical transmission line 55 and a downbound optical transmission line 35.

The OADM function unit 512 has a same configuration as that of the OADM function unit 511 described above and is connected to the optical transmission apparatus 60 via optical transmission lines.

The CD function unit 550 includes a CD multiplexing unit 551, a CD demultiplexing unit 552, a second OSC transmission and reception unit 553, the second LCN transmission and reception unit 554, and the second supervisory control unit 555.

The CD multiplexing unit 551 wavelength-division-multiplexes WDM signals of designated wavelengths output from transponder units 550-1 to 550-n which are housed on a client side of the CD function unit 550 and outputs the wavelength-division-multiplexed WDM signals to the OADM function units 511 and 512 in desired routes. The CD demultiplexing unit 552 outputs WDM signals of the designated wavelengths output from the OADM function units 511 and 512 to the transponder units 550-1 to 550-n housed.

The second OSC transmission and reception unit 553 transmits and receives a supervisory control signal to and from the adjacent optical transmission apparatus 30 via the optical transmission lines. The second LCN transmission and reception unit 554 transmits and receives supervisory control information to and from each function unit inside the optical transmission apparatus 500 using an LCN signal. The second supervisory control unit 555 is responsible for input and output of supervisory control information based on an LCN signal inside the optical transmission apparatus 500 and supervisory control information based on an OSC signal between optical transmission apparatuses.

Although not illustrated in FIG. 5, the CD multiplexing unit 551 and the CD demultiplexing unit 552 each include a WSS or a multiport optical switch which is capable of arbitrarily designating I/O routes between the transponder units 550-1 to 550-n and the OADM function units 511 and 512, in addition to an optical multiplexer and demultiplexer. The CD multiplexing unit 551 and the CD demultiplexing unit 552 also each include an optical amplifier which amplifies the light level of a WDM signal to compensate for an optical loss in the CD function unit. The CD function unit 560 has a same configuration as that of the CD function unit 550 described above, and transponder units 560-1 to 560-n are housed on a client side.

The optical transmission apparatus 500 includes a WDM coupler 591 which couples OSC signals output from the first OSC transmission and reception unit 505 and the second OSC transmission and reception unit 553 into a WDM signal and sends out the coupled signal to the adjacent optical transmission apparatus 30. The optical transmission apparatus 500 includes a WDM splitter 592 which splits OSC signals received from the adjacent optical transmission apparatus 30 from a WDM signal and outputs the OSC signals to the first OSC transmission and reception unit 505 and the second OSC transmission and reception unit 553. The optical transmission apparatus 500 also includes a WDM coupler 593 and a WDM splitter 594 for OSC signals to be transmitted and received to and from the optical transmission apparatus 60 adjacent in a different direction to the optical transmission apparatus 500.

Additionally, the OADM function units 511 and 512 and the CD function units 550 and 560 in the optical transmission apparatus 500 constitute a local supervisory control network based on an LCN signal and having a ring shape (indicated by an alternate long and short dash line in FIG. 5). Supervisory control information inside a site where the optical transmission apparatus 500 is housed and supervisory control information for an OSC-signal-based supervisory control network between the optical transmission apparatus 500 and the facing optical transmission apparatus 60 on the downstream side are transmitted and received to and from the NMS 1 via OSC signals exchanged with the facing optical transmission apparatus 30 on the upstream side.

The optical transmission apparatus 30 that is arranged upstream of and to face the optical transmission apparatus 500 and connects with the optical transmission apparatus 500 via optical transmission lines includes the first OSC transmission and reception unit 505 that transmits and receives supervisory control information for a supervisory control network to and from the optical transmission apparatus 500, and an OSC multiplexing unit 391 and an OSC demultiplexing unit 392. With this configuration, the optical transmission apparatus 30 has a connection form capable of OSC transmission and reception to and from the OADM function unit 511 or the CD function unit 550 of the optical transmission apparatus 500.

The optical transmission apparatus 30 may include the second OSC transmission and reception unit 553 at a CD function unit 350 in addition to the first OSC transmission and reception unit 505 at the OADM function unit 512, like the optical transmission apparatus 500. Although not illustrated in the drawing of the optical transmission apparatus 30 illustrated in FIG. 5, the optical transmission apparatus 30 includes a similar OSC transmission and reception unit and a similar OADM function unit for each of the optical transmission apparatuses 20 and 40 (see FIG. 1) that face the optical transmission apparatus 30 in different directions from a direction for the optical transmission apparatus 500. With this configuration, the optical transmission apparatus 30 constitutes a local supervisory control network based on an LCN signal and having a ring shape among optical transmission devices housed at a same site, like the optical transmission apparatus 500.

The optical transmission apparatus 60 that is arranged downstream of and to face the optical transmission apparatus 500 and connects with the optical transmission apparatus 500 via optical transmission lines also includes the first OSC transmission and reception unit 505 that transmits and receives supervisory control information for a supervisory control network to and from the optical transmission apparatus 500, and an OSC multiplexing unit 691 and an OSC demultiplexing unit 692. With this configuration, the optical transmission apparatus 60 has a connection form capable of OSC transmission and reception to and from the OADM function unit 512 or the CD function unit 560 of the optical transmission apparatus 500.

The optical transmission apparatus 60 may include the second OSC transmission and reception unit 553 at a CD function unit 650 in addition to the first OSC transmission and reception unit 505 at the OADM function unit 511, like the optical transmission apparatus 500. Although not illustrated in the drawing of the optical transmission apparatus 60 illustrated in FIG. 5, the optical transmission apparatus 60 includes a similar OSC transmission and reception unit and a similar OADM function unit for each of the optical transmission apparatuses 70 and 80 (see FIG. 1) that face the optical transmission apparatus 60 in different directions from a direction for the optical transmission apparatus 500. With this configuration, the optical transmission apparatus 60 constitutes a local network based on an LCN signal and having a ring shape among optical transmission devices housed at a same site, like the optical transmission apparatus 500.

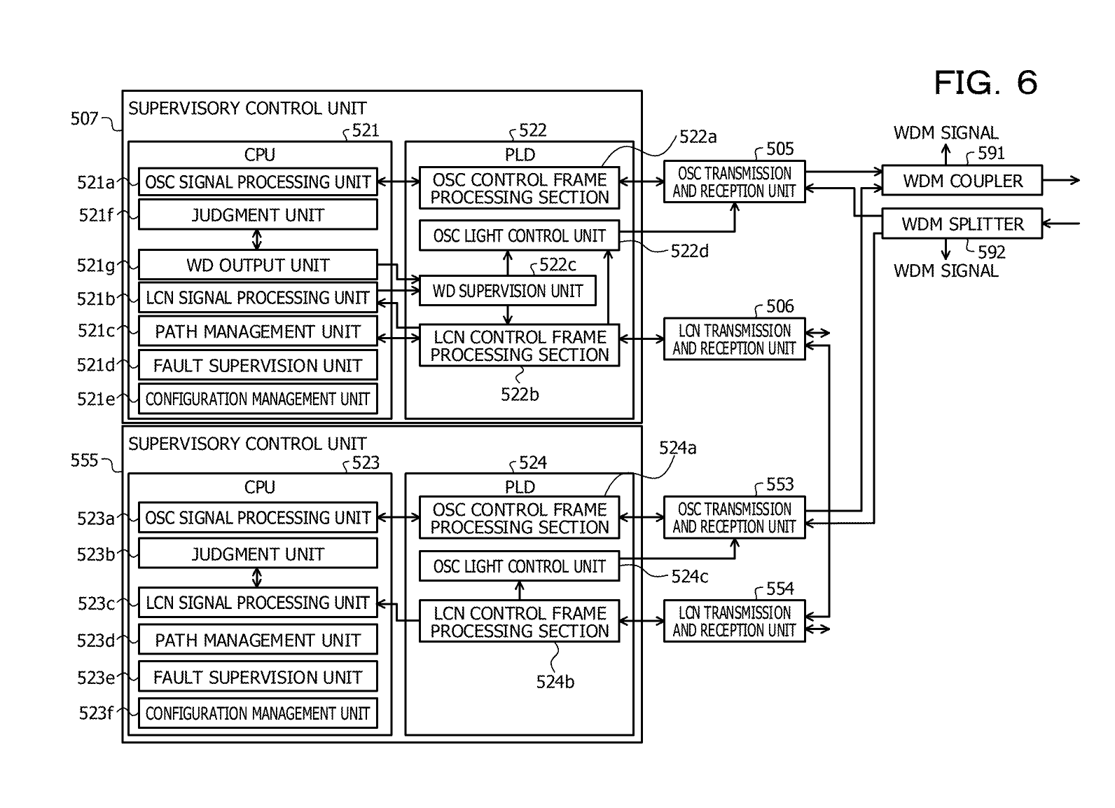

FIG. 6 is a diagram illustrating an example of a hardware configuration of redundant supervisory control units of the optical transmission apparatus according to the first embodiment. The second supervisory control unit 555 is provided as a backup for the first supervisory control unit 507 and operates during a period when supervisory control by the first supervisory control unit 507 is in a stopped state.

Details of the first OSC transmission and reception unit 505, the first LCN transmission and reception unit 506, and the first supervisory control unit 507 handling supervisory control information that are provided in the OADM function unit 511 of the optical transmission apparatus 500 illustrated in FIG. 5 will be described below. Details of the second OSC transmission and reception unit 553, the second LCN transmission and reception unit 554, and the second supervisory control unit 555 handling supervisory control information that are included in the CD function unit 550 will also be described.

Units of the first supervisory control unit 507 illustrated in FIG. 6 will be described. The first supervisory control unit 507 includes a central processing unit (CPU) 521 and a programmable semiconductor device (programmable logic device (PLD)) 522. The CPU 521 executes a program stored in a ROM or the like (not illustrated) and uses a RAM or the like as a work region at the time of the execution.

The CPU 521 transmits and receives an OSC signal control frame which is employed in a supervisory control network for the optical transmission system via the first OSC transmission and reception unit 505. The CPU 521 includes a first OSC signal processing unit 521a, a first LCN signal processing unit 521b, a first path management unit 521c, a first fault supervision unit 521d, a first configuration management unit 521e, a judgment unit 521f, and a watchdog (WD) output unit 521g.

The first OSC signal processing unit 521a processes supervisory control information from the facing optical transmission apparatus 30. The first LCN signal processing unit 521b transmits and receives an LCN signal control frame which is employed in a supervisory control network inside the optical transmission apparatus via the first LCN transmission and reception unit 506 and processes supervisory control information from an optical transmission device disposed at a same site. The first path management unit 521c manages a WDM signal path route in the optical transmission apparatus 500. The first fault supervision unit 521d watches for alarm information which is generated inside the optical transmission apparatus 500.

The first configuration management unit 521e manages configuration information regarding an OADM function unit and a CD function unit inside the optical transmission apparatus 500 and LCN-based in-site supervision network configuration information. The judgment unit 521f judges whether the operating status of the CPU 521 is normal. At this time, the judgment unit 521f periodically transmits a signal indicating normal operation of the CPU 521 to the PLD 522, using the WD output unit 521g.

The PLD 522 includes a first OSC control frame processing unit 522a, a first LCN control frame processing unit 522b, a watchdog (WD) supervision unit 522c, and a first OSC light control unit 522d.

The first OSC control frame processing unit 522a transmits and receives an OSC signal control frame via the first OSC transmission and reception unit 505. The first LCN control frame processing unit 522b transmits and receives an LCN signal control frame via the first LCN transmission and reception unit 506. The WD supervision unit 522c supervises the operating status of the CPU based on a signal output from the WD output unit 521g. The first OSC light control unit 522d performs optical output control on a first OSC light signal.

Units of the second supervisory control unit 555 illustrated in FIG. 6 will next be described. The second supervisory control unit 555 includes a CPU 523 and a PLD 524, like the first supervisory control unit 507.

The CPU 523 of the second supervisory control unit 555 includes a second OSC signal processing unit 523a, a judgment unit 523b, a second LCN signal processing unit 523c, a second path management unit 523d, a second fault supervision unit 523e, and a second configuration management unit 523f.

The second OSC signal processing unit 523a processes supervisory control information from the facing optical transmission apparatus via the second OSC transmission and reception unit 553. The judgment unit 523b judges whether supervisory operation by the first supervisory control unit 507 is in the stopped state, and activates the second supervisory control unit 555 if the first supervisory control unit 507 is in the stopped state. The second LCN signal processing unit 523c processes supervisory control information from an optical transmission device disposed at the same site via the second LCN transmission and reception unit 554. The second path management unit 523d manages a WDM signal path route in the optical transmission apparatus 500. The second fault supervision unit 523e watches for alarm information which is generated inside the optical transmission apparatus 500. The second configuration management unit 523f manages configuration information regarding the OADM function unit 511 and the CD function unit 550 inside the optical transmission apparatus 500 and an LCN-based in-site supervision network.

The PLD 524 of the second supervisory control unit 555 includes a second OSC control frame processing unit 524a, a second LCN control frame processing unit 524b, and a second OSC light control unit 524c.

The second OSC control frame processing unit 524a transmits and receives an OSC signal control frame via the second OSC transmission and reception unit 553. The second LCN control frame processing unit 524b transmits and receives an LCN signal control frame via the second LCN transmission and reception unit 554. The second OSC light control unit 524c performs optical output control on a second OSC light signal.

Operation of the constituent units illustrated in FIG. 6 will be described. The first OSC signal processing unit 521a of the CPU 521 supervises an OSC signal which is received by the first OSC transmission and reception unit 505 and includes WDM signal path information, apparatus configuration information for the optical transmission apparatus 500, and in-site supervision network information. The first OSC signal processing unit 521a outputs alarm information for the optical transmission apparatus 500 to be watched for by the first fault supervision unit 521d to the first OSC control frame processing unit 522a and transmits the alarm information to the facing optical transmission apparatus 30.

The first LCN signal processing unit 521b receives alarm information detected by a different transmission device disposed at the same site inside the optical transmission apparatus 500. The first LCN signal processing unit 521b outputs WDM signal path route information owned by the first path management unit 521c to the first LCN control frame processing unit 522b to transmit the path route information to the different transmission device connected to the first LCN transmission and reception unit 506. The different transmission device is a different transmission device (the OADM function unit 512 or the CD function unit 550 or 560) as viewed from the OADM function unit 511 provided with the first LCN transmission and reception unit 506 illustrated in FIG. 5.

The first path management unit 521c outputs WDM signal path route information set from the NMS 1 to a different transmission device disposed at the same site inside the optical transmission apparatus 500 via the first LCN signal processing unit 521b. The first path management unit 521c performs opening control of a WDM signal path for the OADM function unit 511 of the optical transmission apparatus 500 in accordance with setting from the NMS 1.

The first fault supervision unit 521d collects alarm information for the OADM function unit 511 of the optical transmission apparatus 500 and supervisory control information from a different transmission device disposed at the same site inside the optical transmission apparatus 500 which is received by the first LCN signal processing unit 521b and outputs the alarm information and the supervisory control information to the first OSC signal processing unit 521a. The first configuration management unit 521e performs management of configuration information regarding transmission devices of the optical transmission apparatus 500 and LCN-based in-site supervisory control network configuration information which are set from the NMS 1 via an OSC signal and management of information transmitted and received in an LCN-based manner to and from transmission devices housed in the optical transmission apparatus 500. The transmission device configuration information managed by the first configuration management unit 521e includes configuration information regarding an in-site transmission device including the second OSC transmission and reception unit 553 and the second supervisory control unit 555.

The first OSC control frame processing unit 522a of the PLD 522 outputs an OSC signal received by the first OSC transmission and reception unit 505 to the first OSC signal processing unit 521a. The first OSC control frame processing unit 522a transmits, as an OSC signal, supervisory control information output by the first OSC signal processing unit 521a to the facing optical transmission apparatus 30.

The first LCN control frame processing unit 522b outputs an LCN signal received by the first LCN transmission and reception unit 506 to the first LCN signal processing unit 521b. The first LCN control frame processing unit 522b transmits, as an LCN signal, supervisory control information output by the first LCN signal processing unit 521b to a different transmission device connected to the first LCN transmission and reception unit 506. Additionally, the first LCN control frame processing unit 522b transmits, as an LCN signal, the operating status of the CPU 521 in the first supervisory control unit 507 supervised by the WD supervision unit 522c and a first OSC light emission status to the different transmission device.

The first OSC light control unit 522d performs emission control for a first OSC based on the operating status of the CPU 521 in the first supervisory control unit 507 supervised by the WD supervision unit 522c and an LCN signal received from the second supervisory control unit 555.

The second supervisory control unit 555 performs same operations as those by the first processing units and management units associated with processes included by the first supervisory control unit 507. That is, the second OSC signal processing unit 523a, the second LCN signal processing unit 523c, the second configuration management unit 523f, the second OSC control frame processing unit 524a, and the second LCN control frame processing unit 524b perform same operations as those by the first processing units of the first supervisory control unit 507.

The second path management unit 523d stores WDM signal path route information output from the first LCN signal processing unit 521b and performs opening control of a WDM signal path for the CD function unit 550 in accordance with setting from the NMS 1. The second fault supervision unit 523e collects alarm information for the CD function unit 550 and supervisory control information from a different transmission device disposed at the same site inside the optical transmission apparatus 500 which is received by the second LCN signal processing unit 523c and outputs the alarm information and the supervisory control information to the second OSC signal processing unit 523a. The second OSC light control unit 524c performs emission control for a second OSC based on an LCN signal received from the first supervisory control unit 507.

In the configuration example illustrated in FIG. 6, the second supervisory control unit 555 included in the CD function unit 550 detects, from an LCN-based supervisory control signal via the second LCN transmission and reception unit 554, that a supervisory control function of the CPU 521 in the first supervisory control unit 507 included in the OADM function unit 511 has stopped. For this reason, the second supervisory control unit 555 transmits and receives supervisory control information at a portion downstream of the optical transmission apparatus 500 of the optical transmission system to and from the NMS 1, using an OSC signal from the second OSC transmission and reception unit 553, and executes a backup supervisory control function during a period when the supervisory control function of the first supervisory control unit 507 is in the stopped state.

While the supervisory control function of the CPU 521 in the first supervisory control unit 507 is in the stopped state, as described above, due to software update or the like, the backup second supervisory control unit 555 is activated. With this configuration, the optical transmission apparatus 500 is capable of transmitting signals input from the transponder units 550-1 to 550-n to the upstream side via the CD function unit 550 and the transmission WSS 501 of the OADM function unit 511, under control of the second supervisory control unit 555. Similarly, the optical transmission apparatus 500 is capable of transmitting the signals to the downstream side via a transmission WSS of the OADM function unit 512. The optical transmission apparatus 500 is capable of outputting WDM signals from the upstream side to the transponder units 550-1 to 550-n via the reception WSS 504 of the OADM function unit 511 and the CD demultiplexing unit 552. Similarly, the optical transmission apparatus 500 is capable of outputting WDM signals from the downstream side to the transponder units 560-1 to 560-n of the CD function unit 560 via a reception WSS of the OADM function unit 512.

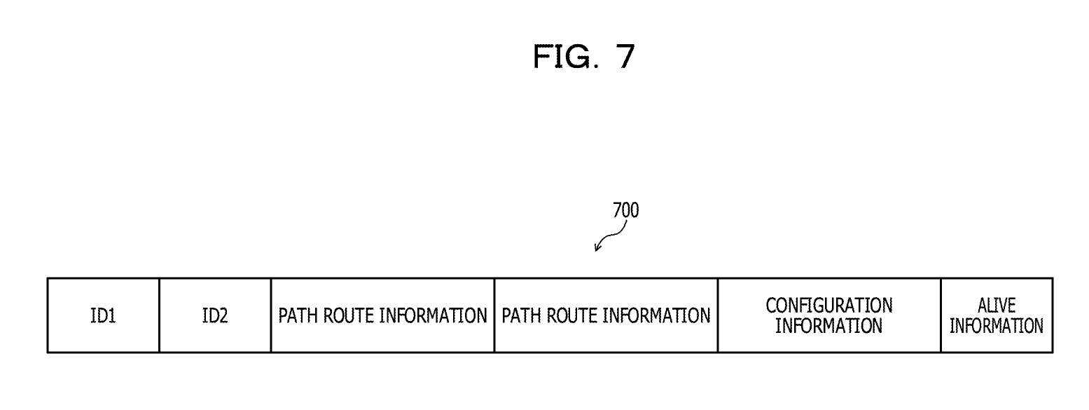

FIG. 7 is a chart illustrating an example of supervisory control information in an LCN signal packet used by an optical transmission apparatus according to the first embodiment. FIG. 7 illustrates an example of supervisory control information 700 in an LCN frame signal packet which is transmitted and received between the first supervisory control unit 507 and the second supervisory control unit 555.

Information transmitted and received as an LCN signal includes ID1 of a transmission device which originates supervisory control information, ID2 of a transmission device as a destination of the supervisory control information, WDM signal path route information for the optical transmission apparatus, and alarm information for the optical transmission apparatus. Additionally, the information transmitted and received as an LCN signal includes supervisory control unit ALIVE information which includes the CPU operating status of a supervisory control unit of a transmission device with a first OSC signal and first and second OSC light emission statuses, in addition to configuration information regarding the optical transmission apparatus and LCN-based network configuration information.

Operation of the supervisory control function of the second supervisory control unit 555 appropriate for the CPU operating status of the first supervisory control unit 507 will next be described.

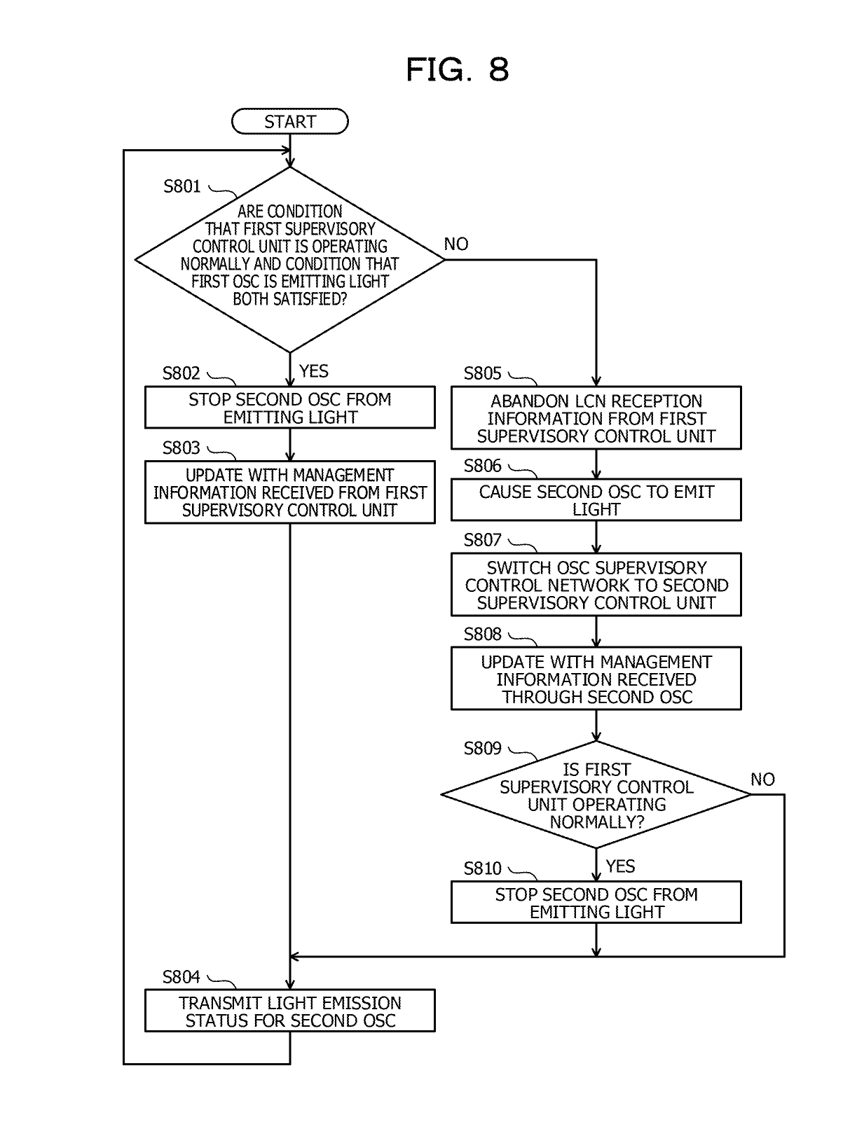

FIG. 8 is a flowchart illustrating an example of supervisory control to be performed by a second supervisory control unit of the optical transmission apparatus according to the first embodiment. FIG. 8 illustrates an example of a supervisory control process to be performed by the second supervisory control unit 555 (the judgment unit 523b of the CPU 523) based on ALIVE information for the first supervisory control unit 507 included in an LCN frame signal in the redundant supervisory control configuration example illustrated in FIG. 6.

The second supervisory control unit 555 (the CPU 523) judges, from ALIVE information received from the first supervisory control unit 507, normal operation of the first supervisory control unit 507 and a light emission status for the first OSC (S801). If the CPU 521 of the first supervisory control unit 507 is operating normally and a first OSC is in a light-emitting state (Yes in S801), the second supervisory control unit 555 brings the second OSC to an emission-stopped state (S802). This inhibits both the first OSC and the second OSC from emitting light to produce an OSC signal in which first and second OSC signal frames are mixed and perform unintentional OSC supervisory control on the facing optical transmission apparatus 30.

The second supervisory control unit 555 then considers information in an LCN signal received from the first supervisory control unit 507 to be valid, and updates pieces of information managed by the second path management unit 523d, the second fault supervision unit 523e, and the second configuration management unit 523f (S803). The second supervisory control unit 555 transmits, as an LCN signal, a light emission status for the second OSC to the first supervisory control unit 507 (S804).

On the other hand, assume, in S801, that the CPU 521 of the first supervisory control unit 507 is in the stopped state or the first OSC is in an emission-stopped state due to software update for the CPU 521 of the first supervisory control unit 507 or CPU resetting for a fault and recovery from the fault. In this case (No in S801), the second supervisory control unit 555 considers pieces of information on path management, fault supervision, and configuration management generated by the CPU 521 of the first supervisory control unit 507 of the LCN signal received from the first supervisory control unit 507 to be invalid and abandons the pieces of information (S805).

The stopped state of the first supervisory control unit 507 causes a fault in an OSC-signal-based supervisory control network from the NMS 1 to the optical transmission apparatus 500 and disables supervisory control on the optical transmission apparatus 500, the optical transmission apparatuses 60 to 80 located downstream of the optical transmission apparatus 500 illustrated in FIG. 5, and optical transmission lines.

At this time, the second supervisory control unit 555 causes the second OSC to emit light (turns on the second OSC) (S806) and uses a second OSC signal. This switches an OSC-signal-based supervisory control network in the optical transmission apparatus 500 to the second supervisory control unit 555 as a backup (S807). With the switching, the second supervisory control unit 555 performs transmission and reception of supervisory control information between the NMS 1 and the optical transmission apparatus 500 using a second OSC signal.

A WDM signal path and optical transmission apparatus configuration information set from the NMS 1 are provided to the optical transmission apparatus 500 via the second OSC transmission and reception unit 553, and pieces of information on path management, fault supervision, and configuration management for the second supervisory control unit 555 are updated (S808). Pieces of information managed by the second path management unit 523d and the second configuration management unit 523f are updated with the pieces of information on path management and configuration management set from the NMS 1 that are received from the second OSC transmission and reception unit 553.

Additionally, information in the second fault supervision unit 523e is updated with alarm information for the CD function unit 550 and supervisory control information from other transmission devices besides the OADM function unit 511 disposed at the same site inside the optical transmission apparatus 500 which is received by the second LCN signal processing unit 523c. The updated information is transmitted to the NMS 1 via the second OSC signal processing unit 523a.

ALIVE information which is generated by the PLD 522 outside the CPU 521 of the first supervisory control unit 507 and includes information on the operating status of the CPU 521 is valid. For this reason, the second supervisory control unit 555 is capable of identifying the first supervisory control unit 507 as a location of fault in a supervisory control network, based on the ALIVE information in an LCN signal received from the first supervisory control unit 507.

A portion from restarting of the CPU 521 of the first supervisory control unit 507 to recovery to normal operation of the supervisory control process by the second supervisory control unit 555 will be described. The second supervisory control unit 555 judges, from ALIVE information received from the first supervisory control unit 507, the operating status of the CPU 521 of the first supervisory control unit 507 (S809). If the CPU 521 of the first supervisory control unit 507 is in the stopped state and is not operating normally (No in S809), the light emission status for the second OSC is transmitted as an LCN signal to the first supervisory control unit 507 (S804). The above-described series of control processes is ended, and the flow returns to S801 to wait for execution.

Assume here that the CPU 521 of the first supervisory control unit 507 has recovered to normal operation after completion of restarting. In this case, the units (the first OSC signal processing unit 521a to the WD output unit 521g) of the CPU 521 start to operate.

A signal is periodically supplied from the WD output unit 521g to the WD supervision unit 522c of the PLD 522 to update ALIVE information to be received from the first supervisory control unit 507. The second supervisory control unit 555 detects, from the ALIVE information, normal operation of the CPU 521 of the first supervisory control unit 507 (Yes in S809). The second supervisory control unit 555 performs emission stop control for the second OSC (S810) and transmits, as an LCN signal, the emission-stopped state (OFF) of the second OSC to the first supervisory control unit 507 (S804).

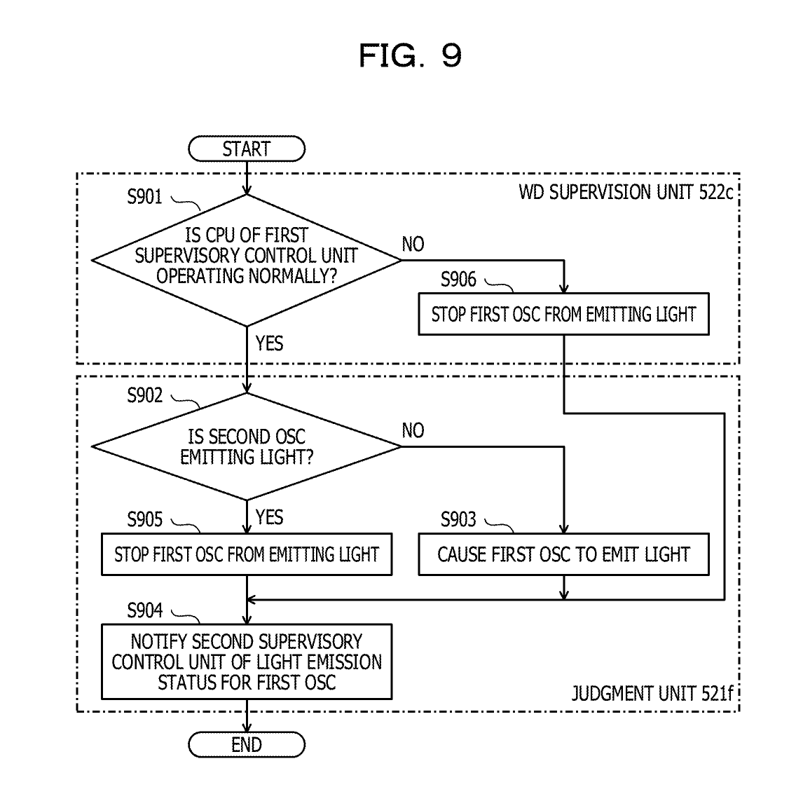

FIG. 9 is a flowchart illustrating an example of supervisory control to be performed by a first supervisory control unit of the optical transmission apparatus according to the first embodiment. FIG. 9 illustrates an example of a supervisory control process to be performed by the first supervisory control unit 507 (the judgment unit 521f and the WD supervision unit 522c) in the redundant supervisory control configuration example illustrated in FIG. 6.

The WD supervision unit 522c of the first supervisory control unit 507 judges the operating status of the CPU 521 of the first supervisory control unit 507 to be supervised (S901). If the CPU 521 of the first supervisory control unit 507 is operating normally (Yes in S901), the judgment unit 521f judges the light emission status for the second OSC that is transmitted from the second supervisory control unit 555 via an LCN signal (S902).

If the second OSC is in the emission-stopped state (No in S902), the judgment unit 521f causes the first OSC to emit light (turns on the first OSC) (S903). The judgment unit 521f then notifies the second supervisory control unit 555 of the light emission status for the first OSC and performs transmission and reception of supervisory control information between the NMS 1 and the optical transmission apparatus 500 (S904).

On the other hand, if the second OSC is in the light-emitting state (Yes in S902), the judgment unit 521f brings the first OSC to the emission-stopped (OFF) state (S905). This inhibits both the first OSC and the second OSC from emitting light to produce an OSC signal in which first and second OSC signal frames are mixed and perform unintentional OSC supervisory control on the facing optical transmission apparatus 30. The judgment unit 521f notifies the second supervisory control unit 555 of the light emission status for the first OSC and performs transmission and reception of supervisory control information between the NMS 1 and the optical transmission apparatus 500 (S904).

If the CPU 521 of the first supervisory control unit 507 is out of operation (No in S901), the WD supervision unit 522c performs emission stop control for the first OSC on the first OSC light control unit 522d (S906). The first LCN control frame processing unit 522b transmits, as an LCN signal, the operating status of the CPU 521 of the first supervisory control unit 507 supervised by the WD supervision unit 522c and the light emission status for the first OSC to the second supervisory control unit 555 (S904).

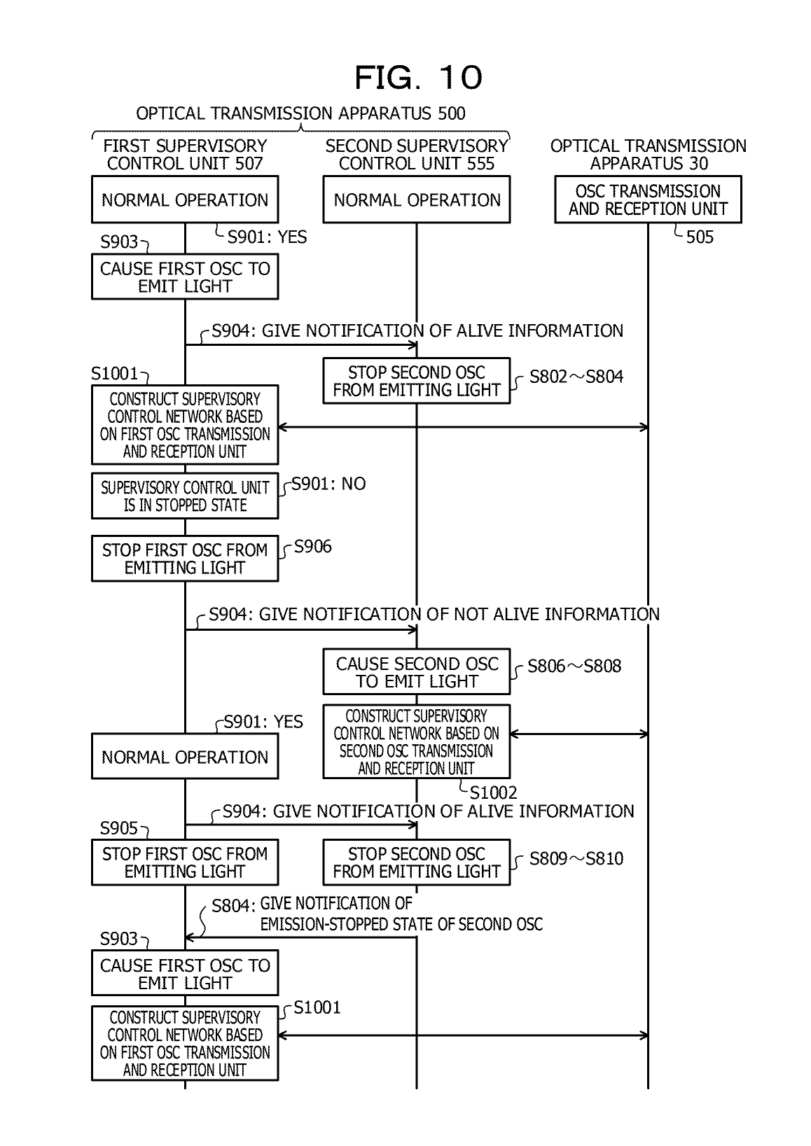

FIG. 10 is a sequence chart illustrating a redundant supervisory control switching process by the optical transmission apparatus according to the first embodiment. FIG. 10 illustrates a control process by the first supervisory control unit 507 and the second supervisory control unit 555 illustrated in FIGS. 8 and 9 from stoppage of the first supervisory control unit 507 to completion of restarting and recovery to normal operation. FIG. 10 uses step numbers in the flowcharts in FIGS. 8 and 9.

When the optical transmission apparatus 500 is in a normal state, the first supervisory control unit 507 is operating normally (Yes in S901). In this case, the first supervisory control unit 507 causes the first OSC to emit light (S903) and constructs a supervisory control network based on a first OSC signal with the NMS 1 via the facing optical transmission apparatus 30 (S1001). The first supervisory control unit 507 stops the second OSC from emitting light (S802 to S804) using ALIVE information in an LCN signal (S904).

If the CPU 521 of the first supervisory control unit 507 stops due to software update for the CPU 521 of the first supervisory control unit 507 or CPU resetting for a fault and recovery from the fault (No in S901), the first OSC stops emitting light (S906). The second supervisory control unit 555 causes the second OSC to emit light (S806) based on ALIVE information (NOT ALIVE) in an LCN signal (S904).

Use of a second OSC signal switches the OSC-signal-based supervisory control network in the optical transmission apparatus 500 from the first supervisory control unit 507 to the second supervisory control unit 555 (S807 and S808). The second supervisory control unit 555 constructs a supervisory control network based on a second OSC signal with the NMS 1 via the facing optical transmission apparatus 30 (S1002).

After that, if the CPU 521 of the first supervisory control unit 507 is restarted and recovers to normal operation (Yes in S901), the first supervisory control unit 507 detects the light emission status for the second OSC and brings the first OSC to the emission-stopped state (S905). The first supervisory control unit 507 then notifies the second supervisory control unit 555 of ALIVE information in an LCN signal (S904).

The second supervisory control unit 555 detects normal operation of the first supervisory control unit 507 from the ALIVE information in the LCN signal (Yes in S809) and performs emission stop control for the second OSC (S810). The second supervisory control unit 555 then transmits, as an LCN signal, the emission-stopped state of the second OSC to the first supervisory control unit 507 (S804).

If the first supervisory control unit 507 detects the emission-stopped state of the second OSC (No in S902), the first supervisory control unit 507 causes the first OSC to emit light and performs transmission and reception of supervisory control information between the NMS 1 and the optical transmission apparatus 500 using a first OSC signal (S903). With this operation, the first supervisory control unit 507 constructs a supervisory control network based on a first OSC signal again with the NMS 1 via the facing optical transmission apparatus 30 (S1001).

Like the above-described process, according to the first embodiment, the supervisory control network is switched from the first supervisory control unit 507 to the backup second supervisory control unit 555 during a period when supervisory control by the first supervisory control unit 507 is in the stopped state. Additionally, supervisory control network switching without causing the first OSC and the second OSC to emit light at the time of switching the supervisory control network from one to the other and from the other back to the one inhibits an OSC signal in which first and second OSC signal frames are mixed from being output to the facing optical transmission apparatus. With OSC signal switching, it is possible to inhibit a mixed OSC signal from serving as an erroneous supervisory control signal and unintentional WDM signal path control from causing a fault and generation of alarm information.

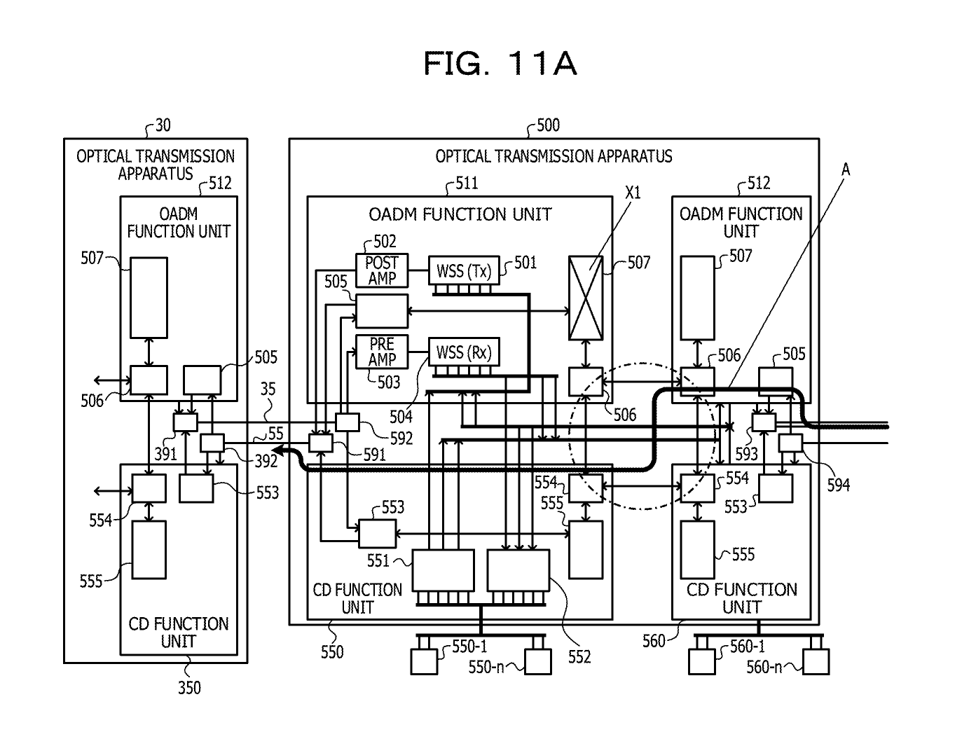

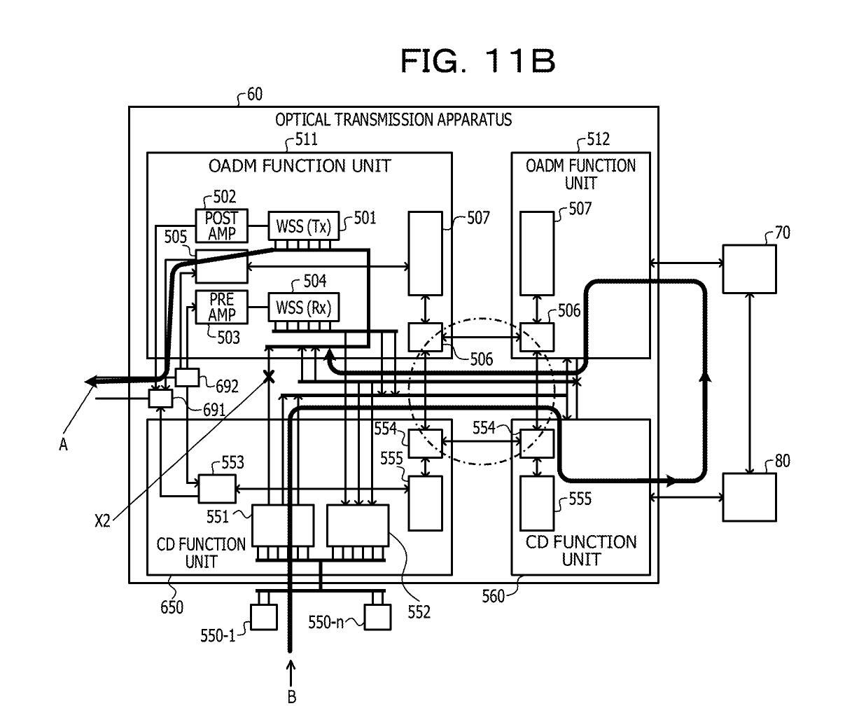

FIGS. 11A and 11B are diagrams for explaining a state in which supervisory control is continuing in the event of a plurality of faults in the optical transmission system using the optical transmission apparatus according to the first embodiment. FIG. 11A illustrates a state in which the supervisory control function (a location X1 in FIG. 11A) of the first supervisory control unit 507 included in the OADM function unit 511 of the optical transmission apparatus 500 is stopped in the optical transmission system illustrated in FIG. 5. FIG. 11B illustrates a state with a fault (a location X2 in FIG. 11B) in a WDM signal path from the CD function unit 650 of the optical transmission apparatus 60 to the OADM function unit 511.

In the optical transmission system in FIGS. 11A and 11B, the OADM function unit 511 of the optical transmission apparatus 60 detects a WDM signal input interruption alarm from the CD function unit 650.

According to a conventional technique, if the first supervisory control unit 507 stops, LCN signal processing and OSC signal processing are inexecutable, as illustrated in FIG. 4. For this reason, the LCN signal processing and the OSC signal processing are blocked by the first supervisory control unit 507 in the stopped state, and thereby apparatus alarm information and path fault information detected by the optical transmission apparatus 60 are not transmitted to the NMS 1.

Consider the case of a configuration in which a supervisory control network for a different layer is constructed using a WDM signal, and the supervisory control network for the different layer is used to transmit and receive supervisory control information for a WDM signal layer (L0), as in the technique according to patent literature 1. Even in this case, if a fault occurs in a WDM signal path in the supervisory control network for the different layer, supervisory control networks for both an L0 network and an Lx network are shut down, and the NMS 1 is incapable of collection of fault information and WDM signal path switching control.

As described above, a conventional technique is incapable of performing switching control for a WDM signal path with a fault. Identification of a location of the fault is hard. For this reason, according to the conventional technique, the network fault continues for a long period of time, and recovery from the fault takes great effort, which causes a problem with network maintenance.

In contrast, in the first embodiment described above, if the first supervisory control unit 507 is in a functionally stopped state, switching to the second supervisory control unit 555 including the second OSC transmission and reception unit 553 is performed, and an OSC supervisory control network for the optical transmission apparatus 500 is constructed. For example, inside the optical transmission apparatus 500, a route through the first supervisory control unit 507 of the OADM function unit 511, supervisory control by which is in the stopped state, is not used, and a detour route through the second supervisory control unit 555 of the CD function unit 550, the second supervisory control unit 555 of the CD function unit 560, and the first supervisory control unit 507 of the OADM function unit 512 is used. As described above, a route indicated by a solid line A in FIGS. 11A and 11B allows the optical transmission apparatus 500 to transmit apparatus alarm information and path fault information detected by the optical transmission apparatus 60 from the second OSC transmission and reception unit 553 to the NMS 1 via the optical transmission apparatus 30.

Additionally, according to the first embodiment, a supervisory control network for the optical transmission system is constructed via the second OSC transmission and reception unit 553 and the second supervisory control unit 555 included in the optical transmission apparatus 500. For this reason, not only identification of a location of fault (the location X2 in FIG. 11B) by the NMS 1 is possible but also path switching control that switches from a WDM signal path through the location X2 with a fault to a different WDM signal path through the optical transmission apparatuses 70 and 80 (a route for an input signal B in FIG. 11B) is possible. This allows maintenance operation that speedily takes measures even in the event of faults at a plurality of locations and implementation of enhancement in supervisory control network reliability.

Moreover, according to the first embodiment, adoption of a redundant configuration in which a second OSC transmission and reception unit is added to a transmission device in a same layer disposed at a site allows implementation of a supervisory control network lower in cost and higher in reliability than according to a conventional technique. For example, a configuration including a complementary supervisory control network in a different layer, as in patent literature 1 described above, is implemented by storing apparatuses in different layers at a same site and demands a large-scale expensive network in which apparatuses in different layers are installed at a same site. In contrast, the first embodiment includes an inexpensive second OSC transmission and reception unit as a backup and has the advantage that a low-cost reliable supervisory control network is constructible only with an optical transmission network in a WDM signal layer.

As has been described above, according to the first embodiment of the present disclosure, an OSC transmission and reception unit which transmits and receives supervisory control information to and from an optical transmission apparatus at a remote site and a supervisory control function are provided at a first transmission device (the OADM function unit 511, for example) which is connected to optical transmission lines and transmits and receives an WDM signal. Additionally, a backup redundant OSC transmission and reception unit and a backup redundant supervisory control function are provided at a second transmission device (the CD function unit 550, for example) in a same layer which is disposed at a same site inside an optical transmission apparatus.

For this reason, even if the supervisory control function of the first transmission device stops to disable transmission and reception of supervisory control information at a remote site, it is possible to transmit and receive supervisory control information at a remote site using the OSC transmission and reception unit and the supervisory control function of the second transmission device and perform path switching to bypass a location of fault and identification of the location of fault. This allows implementation of a simple and low-cost supervisory control network enhanced in maintainability and reliability.

### Second Embodiment

A second embodiment of the present disclosure will next be described. As in FIG. 5, the optical transmission apparatus 500 according to the first embodiment includes the WDM coupler 591 and the WDM splitter 592 that perform coupling into and splitting from a WDM signal for the first OSC transmission and reception unit 505 and the second OSC transmission and reception unit 553 in order to transmit and receive an OSC signal to and from the optical transmission apparatus 30 connected via optical transmission lines. In the second embodiment, optical switches capable of switching an OSC signal route are further provided at OSC multiplexing and demultiplexing portions between a first OSC transmission and reception unit 505 and a second OSC transmission and reception unit 553.

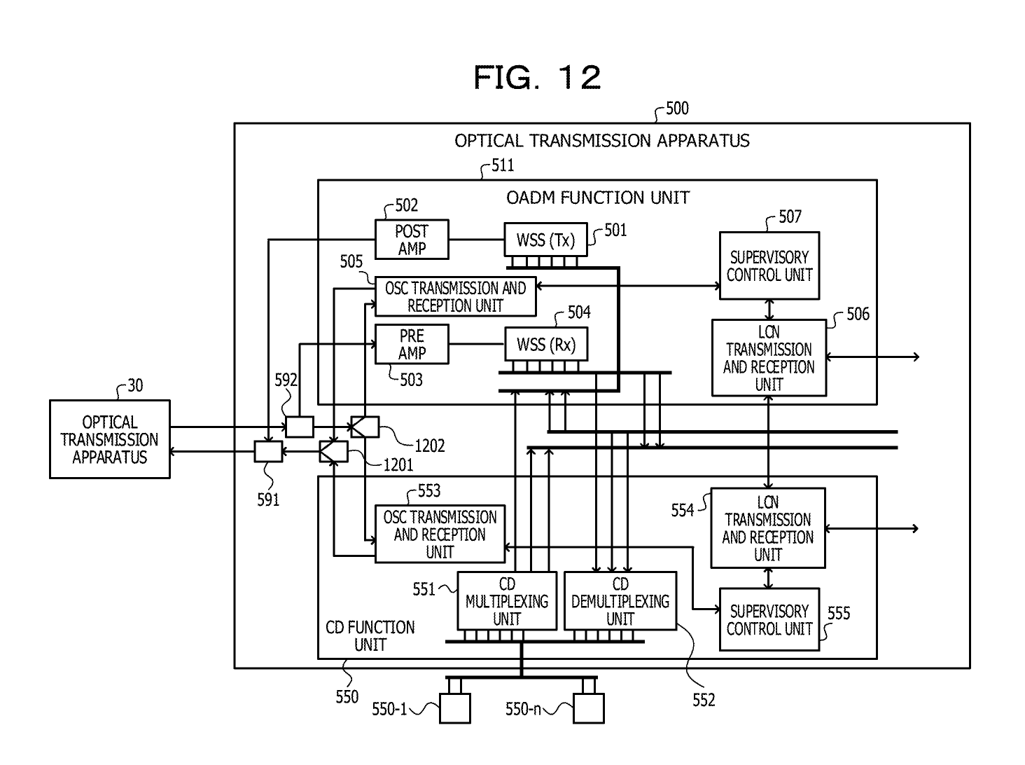

FIG. 12 is a diagram illustrating an example of a configuration of an optical transmission apparatus according to the second embodiment. An optical transmission apparatus 500 illustrated in FIG. 12 has components of the optical transmission apparatus 500 illustrated in FIG. 5. A first optical switch 1201 is provided between the first OSC transmission and reception unit 505 and the second OSC transmission and reception unit 553 and a WDM coupler 591. A second optical switch 1202 is provided between the first OSC transmission and reception unit 505 and the second OSC transmission and reception unit 553 and a WDM splitter 592.

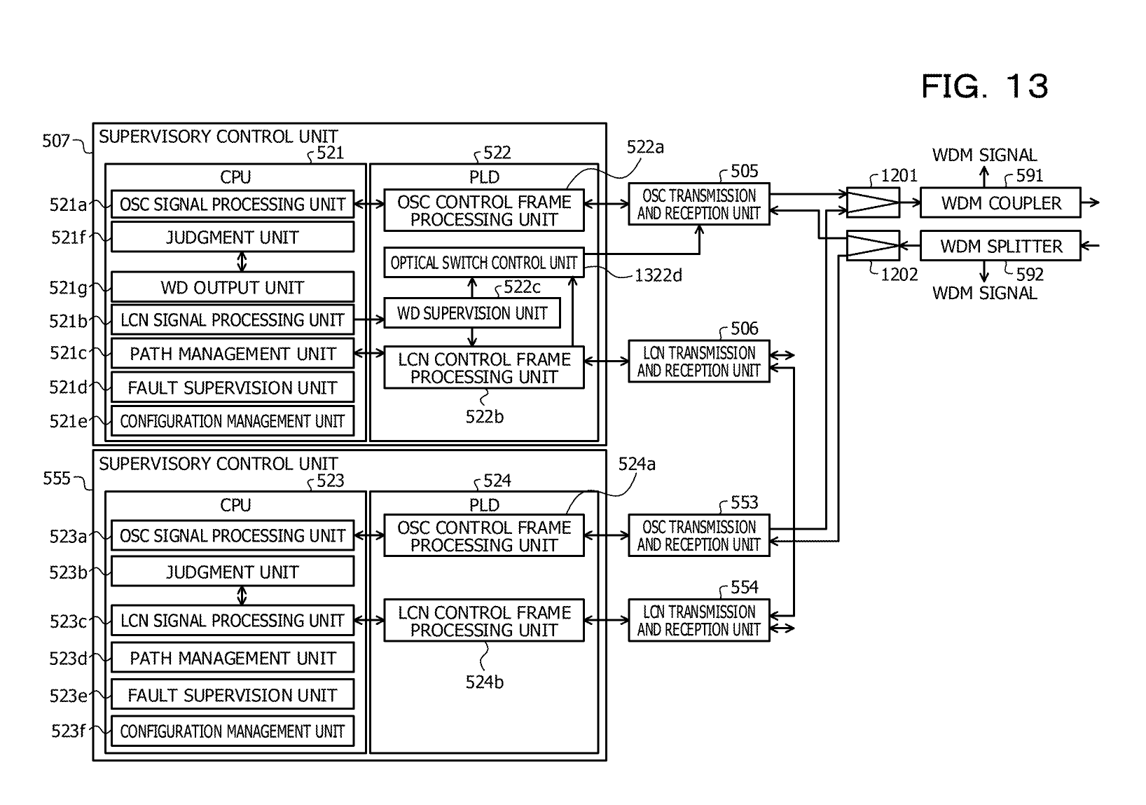

FIG. 13 is a diagram illustrating an example of a hardware configuration of redundant supervisory control units of the optical transmission apparatus according to the second embodiment. FIG. 13 illustrates an example of a detailed configuration of the first OSC transmission and reception unit 505 and a first LCN transmission and reception unit 506 which are provided in an OADM function unit 511, the first optical switch 1201, and a first supervisory control unit 507 which handles supervisory control information of the optical transmission apparatus 500 illustrated in FIG. 12. FIG. 13 illustrates an example of a detailed configuration of the second OSC transmission and reception unit 553 and a second LCN transmission and reception unit 554 which are provided in a CD function unit 550, the second optical switch 1202, and a second supervisory control unit 555 which handles supervisory control information.

An optical switch control unit 1322d is provided in a PLD 522 of the first supervisory control unit 507, instead of the first OSC light control unit 522d (see FIG. 6) that is used in the first embodiment and performs optical output control on a first OSC light signal. Configurations and operation of other components are the same as those of the first supervisory control unit 507 illustrated in the first embodiment (see FIG. 6).

The second OSC light control unit 524c (see FIG. 6) that performs optical output control on a second OSC light signal used in the first embodiment is not included in a PLD 524 of the second supervisory control unit 555. Configurations and operation of other components are the same as those of the second supervisory control unit 555 illustrated in the first embodiment (see FIG. 6).

Operation of the optical switch control unit 1322d described above will be described. The optical switch control unit 1322d performs route switching control of the first and second optical switches 1201 and 1202 based on the operating status of a CPU 521 of the first supervisory control unit 507 supervised by a WD supervision unit 522c.

Assume that stoppage of a supervisory control function of the CPU 521 of the first supervisory control unit 507 included in the OADM function unit 511 is detected by the WD supervision unit 522c. In this case, the optical switch control unit 1322d performs route switching on the first and second optical switches 1201 and 1202. The second supervisory control unit 555 transmits and receives supervisory control information for an optical transmission system downstream of the optical transmission apparatus 500 to and from an NMS 1 using an OSC signal from the second OSC transmission and reception unit 553 and causes supervisory control as a backup of the first supervisory control unit 507 to function.

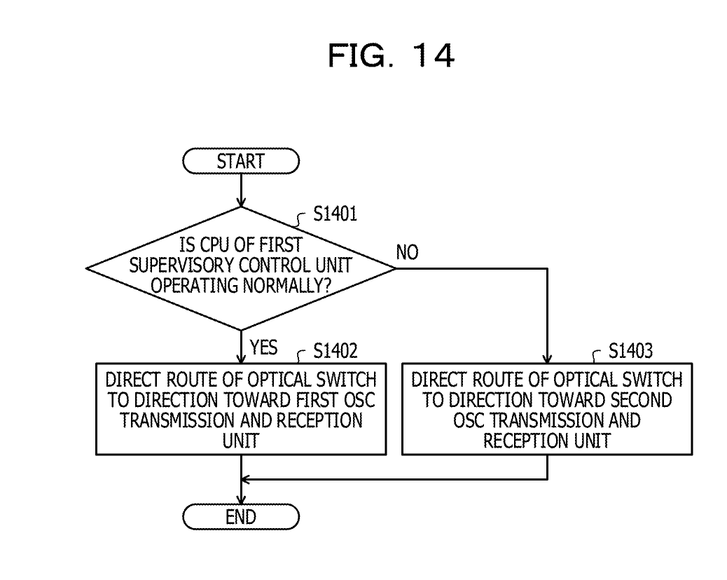

FIG. 14 is a flowchart illustrating an example of supervisory control to be performed by a first supervisory control unit of the optical transmission apparatus according to the second embodiment. FIG. 14 illustrates an example of a supervisory control process to be performed by the first supervisory control unit 507 (the WD supervision unit 522c and the optical switch control unit 1322d) in the redundant supervisory control configuration example illustrated in FIG. 13.

The WD supervision unit 522c judges the operating status of the CPU 521 of the first supervisory control unit 507 (S1401). If the CPU 521 of the first supervisory control unit 507 is operating normally (Yes in S1401), the optical switch control unit 1322d gives an instruction to switch routes of the first and second optical switches 1201 and 1202 to the first OSC transmission and reception unit 505 (S1402).

Assume that the CPU 521 of the first supervisory control unit 507 is in a stopped state due to software update for the CPU 521 of the first supervisory control unit 507 or resetting of the CPU 521 for a fault and recovery from the fault (No in S1401). In this case, the optical switch control unit 1322d gives an instruction to switch the routes of the first and second optical switches 1201 and 1202 to the second OSC transmission and reception unit 553 (S1403). A first LCN control frame processing unit 522b transmits, as an LCN signal, the operating status of the CPU 521 of the first supervisory control unit 507 supervised by the WD supervision unit 522c to the second supervisory control unit 555.

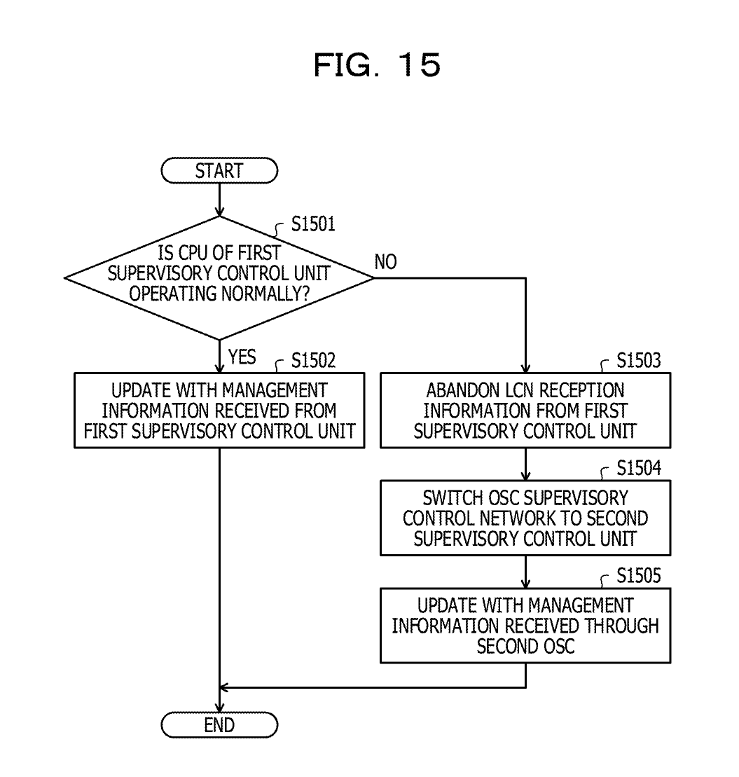

FIG. 15 is a flowchart illustrating an example of supervisory control to be performed by a second supervisory control unit of the optical transmission apparatus according to the second embodiment. FIG. 15 illustrates an example of a supervisory control process to be performed by the second supervisory control unit 555 (a judgment unit 523b of a CPU 523) based on ALIVE information for the first supervisory control unit 507 included in an LCN frame signal in the redundant supervisory control configuration example illustrated in FIG. 13.

The second supervisory control unit 555 judges, from ALIVE information received from the first supervisory control unit 507, whether the CPU 521 of the first supervisory control unit 507 is operating normally (S1501). If the CPU 521 of the first supervisory control unit 507 is operating normally (Yes in S1501), the second supervisory control unit 555 judges that information in an LCN signal received from the first supervisory control unit 507 to be valid. The second supervisory control unit 555 updates pieces of information managed by a second path management unit 523d, a second fault supervision unit 523e, and a second configuration management unit 523f (S1502).

On the other hand, assume that the CPU 521 of the first supervisory control unit 507 is in the stopped state (No in S1501). In this case, the second supervisory control unit 555 judges pieces of information on path management, fault supervision, and configuration management generated by the CPU 521 of the first supervisory control unit 507 of an LCN signal received from the first supervisory control unit 507 to be invalid and abandons the pieces of information (S1503).

In the above-described case, the stopped state of the CPU 521 of the first supervisory control unit 507 causes a fault in an OSC-signal-based supervisory control network from the NMS 1 to the optical transmission apparatus 500. The fault disables supervisory control on the optical transmission apparatus 500 illustrated in FIG. 5, optical transmission apparatuses downstream of the optical transmission apparatus 500, and optical transmission lines.

At this time, the optical switch control unit 1322d of the first supervisory control unit 507 gives an instruction to switch the routes of the first and second optical switches 1201 and 1202 to the second OSC transmission and reception unit 553 (S1403 in FIG. 14). Use of a second OSC signal switches an OSC-signal-based supervisory control network in the optical transmission apparatus 500 to the second supervisory control unit 555 (S1504).

With the above-described switching, the second supervisory control unit 555 performs transmission and reception of supervisory control information between the NMS 1 and the optical transmission apparatus 500 using a second OSC signal, and pieces of information on path management, fault supervision, and configuration management by the second supervisory control unit 555 are updated (S1505).

Here, ALIVE information which is generated by the PLD 522 outside the CPU 521 of the first supervisory control unit 507 and includes information on the operating status of the CPU 521 is valid. For this reason, the second supervisory control unit 555 is capable of identifying the first supervisory control unit 507 as a location of fault in a supervisory control network, based on the ALIVE information in an LCN signal received from the first supervisory control unit 507.

After the CPU 521 of the first supervisory control unit 507 is restarted and recovers to normal operation, the processes in S1501 (Yes in S1501) and S1502 in FIG. 15 are executed.

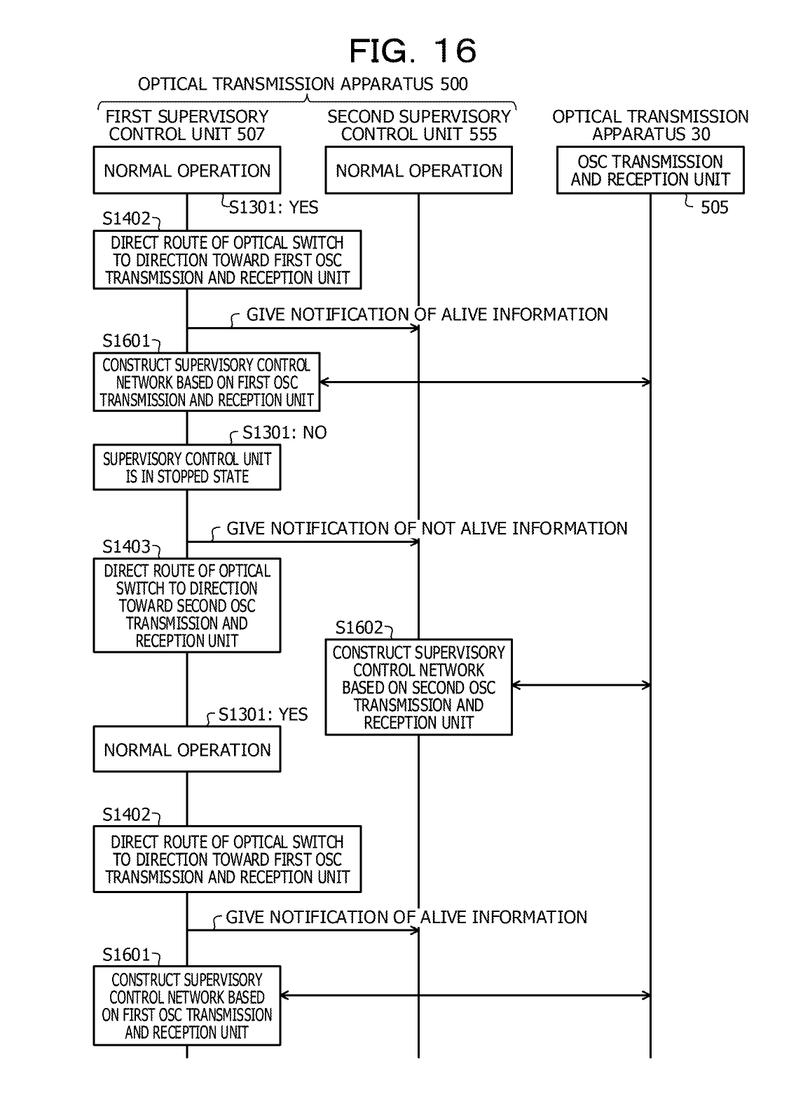

FIG. 16 is a sequence chart illustrating a redundant supervisory control switching process by the optical transmission apparatus according to the second embodiment. FIG. 16 illustrates a control process by the first supervisory control unit 507 and the second supervisory control unit 555 illustrated in FIGS. 14 and 15 from stoppage of the first supervisory control unit 507 to completion of restarting and recovery to normal operation. FIG. 16 uses step numbers in the flowcharts in FIGS. 14 and 15.

When the optical transmission apparatus 500 is in a normal state, the CPU 521 of the first supervisory control unit 507 is operating normally (Yes in S1301). In this case, the optical switch control unit 1322d directs the routes to the first OSC transmission and reception unit 505 (S1402), and the optical transmission apparatus 500 constructs an OSC-signal-based supervisory control network with the facing optical transmission apparatus 30 using a first OSC signal (S1601).

Assume here that the CPU 521 of the first supervisory control unit 507 is in the stopped state due to software update for the first supervisory control unit 507 or resetting of the CPU 521 for a fault and recovery from the fault (No in S1301). In this case, the optical switch control unit 1322d gives an instruction to switch the routes to the second OSC transmission and reception unit 553 (S1403). Use of a second OSC signal switches the OSC-signal-based supervisory control network in the optical transmission apparatus 500 to the second supervisory control unit 555. The optical transmission apparatus 500 constructs an OSC-signal-based supervisory control network with the facing optical transmission apparatus 30 using a second OSC signal (S1602).

Assume that the CPU 521 of the first supervisory control unit 507 has been restarted and has recovered to normal operation after that (Yes in S1301). In this case, the optical switch control unit 1322d directs the routes to the first OSC transmission and reception unit 505 (S1402) and constructs an OSC-signal-based supervisory control network with the facing optical transmission apparatus 30 using a first OSC signal (S1601).

As a different configuration example according to the second embodiment, the optical switch control unit 1322d provided at the first supervisory control unit 507 illustrated in FIG. 13 may be provided at the second supervisory control unit 555. In this case, the optical switch control unit 1322d performs route switching control of the first and second optical switches 1201 and 1202 based on ALIVE information for the first supervisory control unit 507 included in an LCN frame signal received by the second LCN transmission and reception unit 554.

The optical switch control unit 1322d gives an instruction to switch the routes of the first and second optical switches 1201 and 1202 to the first OSC transmission and reception unit 505 based on the ALIVE information for the first supervisory control unit 507 when the CPU 521 of the first supervisory control unit 507 is in operation. The optical switch control unit 1322d gives an instruction to switch the routes of the first and second optical switches 1201 and 1202 to the second OSC transmission and reception unit 553 when the CPU 521 of the first supervisory control unit 507 is out of operation. Even such a different configuration example is capable of obtaining same working effects as those of the second embodiment.

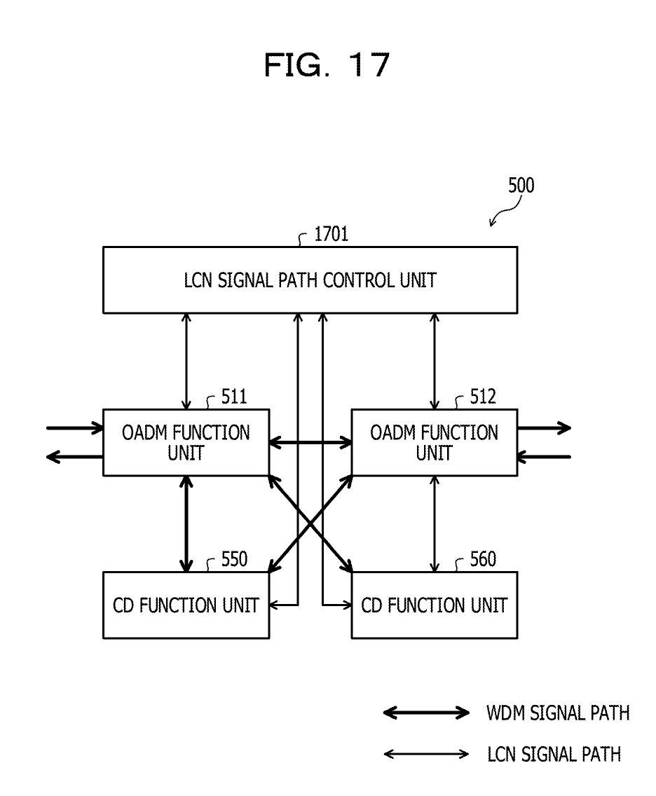

FIG. 17 is a diagram illustrating an example of a configuration of a different optical transmission apparatus according to the second embodiment. The first embodiment and the second embodiment described above have been described using an example in which an LCN supervisory control network inside the optical transmission apparatus 500 is a ring-shaped supervisory control network (see FIG. 5). The present disclosure is not limited to this. LCN supervisory control may have a hub configuration, as illustrated in FIG. 17, and a supervisory control network may be switched via an LCN signal path control unit 1701 which serves as a hub.

According to the above-described second embodiment, a supervisory control network is switched from the first supervisory control unit 507 to the second supervisory control unit 555 when supervisory control by the first supervisory control unit 507 stops, like the first embodiment. This allows speedy reconstruction of a supervisory control network with the NMS 1 and speedy maintenance operation. Additionally, according to the second embodiment, a route switching instruction with additional optical switches inhibits first and second OSC signal frames from being mixed and allows implementation of a simple and lower-cost supervisory control network enhanced in maintainability and reliability.

According to each of the above-described embodiments, an optical transmission apparatus is provided with redundant OSC transmission and reception units that transmit and receive supervisory control information to and from an optical transmission apparatus at a remote site and redundant supervisory control units. The OSC transmission and reception units and the supervisory control units are provided at a first transmission device (an OADM function unit, for example) which is connected to optical transmission lines and transmits and receives a WDM signal and at a second transmission device (a CD function unit, for example) in a same layer which is disposed at a same site inside the optical transmission apparatus.

Here, the second transmission device is different in function from the first transmission device and is not obtained simply by duplicating a function (an OADM function unit, for example) of the first transmission device. A redundant configuration with a bifurcated OSC for sending out supervisory control information at all times is adopted. Thus, the redundant configuration is not an undesired redundant configuration and does not involve high costs.

Even if a supervisory control function of a CPU of the first transmission device stops due to software update or the like, and the first transmission device is incapable of transmitting and receiving supervisory control information at a remote site, supervisory control information at the remote site is transmittable and receivable using the OSC transmission and reception unit and a supervisory control function of the second transmission device. This makes it possible to notify an NMS of a fault occurrence status on a network, enhance the maintainability and reliability of a supervisory control network, and perform low-cost supervisory control.

In contrast, according to a conventional technique, redundant transmission devices are not provided. Stoppage of a supervisory control function inside an optical transmission apparatus disables transmission and reception of supervisory control information at a remote site and transmission of notification to the NMS. As in patent literature 1, an L0 network is used as an Lx supervisory control network in a supervisory control network for an Lx network. If a fault occurs in the L0 network, transmission of notification of a location of fault in the Lx network to an NMS is hard.

In the above-described respect, according to the embodiment, redundant OSC-based supervisory control functions are provided. Even if the supervision function of the first transmission device inside the optical transmission apparatus stops, ongoing transmission and reception of supervisory control information inside the optical transmission apparatus and supervisory control information at a remote site is possible using the second transmission device.

The redundantly provided supervisory control units perform sending-out for only an OSC for a transmission device in operation without causing an OSC for the first transmission device and an OSC for the second transmission device to emit light at the time of switching a supervisory control network from one to the other and from the other back to the one. A configuration in which an OSC signal to be sent out by the OSC transmission and reception units for the redundant supervisory control units is switched with an optical switch, and only a supervisory control unit in operation sends out an OSC signal to the supervisory control network (network) may be adopted. This inhibits an OSC signal in which OSC signal frames for the first and second transmission devices are mixed from being output to a facing optical transmission apparatus. With OSC signal switching, it is possible to inhibit a mixed OSC signal from serving as an erroneous supervisory control signal and unintentional WDM signal path control from causing a fault and generation of alarm information.

Additionally, adoption of a configuration in which supervisory control information is transmitted and received in a ring shape or a hub shape between the first transmission device and the second transmission device using an LCN inside the optical transmission apparatus allows path switching to detour around a location of fault inside the optical transmission apparatus. It is thus possible to notify the NMS of supervisory control information inside the optical transmission apparatus and supervisory control information at a remote site and identify a location of fault even when supervisory control by the first transmission device is in a stopped state.

The first transmission device has a CPU and a programmable semiconductor device. The programmable semiconductor device is capable of more easily detecting stoppage of supervisory control due to, for example, resetting associated with software update for the CPU. The stoppage of the supervisory control by the CPU of the first transmission device is easily detectable using a watchdog timer.

The embodiment has described an example in which a supervisory control unit stops due to CPU upgrading or the like. Since a configuration with redundant OSC supervisory control is adopted, it is possible to switch to supervisory control by a different function unit and continue OSC-based supervisory control even when a function unit without any CPU stops. For example, the present disclosure is applied to an optical transmission apparatus with a blade configuration in which a blade is insertable and removable (addable) for each function unit. This makes it possible to continue supervisory control with a different blade even when a function stops due to a failure in a blade or the like, continue transmission and reception of supervisory control information at a remote site, and identify a location of failure.

Supervisory control information according to the embodiment is for a supervisory control network not of an out-of-band type in which the reliability of supervision of a WDM signal line is impaired but of an in-band type in which a same optical transmission line as one for a WDM signal (main signal) is used, which allows enhancement in the reliability of network fault supervision. A redundant configuration which has a ring or hub connection and is capable of detouring the supervisory control information inside a local optical transmission apparatus is adopted, and supervisory control with high reliability is possible without impairing advantages of the in-band type.

An optical transmission method described in each of the present embodiments is implemented by a computer (a processor, for example) of a target device or the like executing a control program prepared in advance. The present control program is recorded on a computer-readable recording medium, such as a magnetic disk, an optical disc, or a universal serial bus (USB) flash memory, and is read out from the recording medium and is executed by the computer. The control program may be distributed over a network, such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical transmission apparatus for transmitting a main signal, the optical transmission apparatus being arranged on an optical transmission line, the optical transmission apparatus comprising:
a first processor configured to perform alarm supervision and signal control of the optical transmission apparatus;
a second processor configured to perform the alarm supervision and the signal control of the optical transmission apparatus during a period when the first processor is in a stopped state;
inter-apparatus transmitter and receivers configured to transmit and receive a signal including control information for the alarm supervision between the first and second processors and another optical transmission apparatus facing the optical transmission apparatus; and
a multiplexer and demultiplexer configured to couple and split the signal for the main signal optically communicated with the another optical transmission apparatus.

2. The optical transmission apparatus according to claim 1, wherein the first processor is configured to:
detect whether a CPU of the first processor is operating normally, and
notify the second processor using the control information when the CPU is in a stopped state.

3. The optical transmission apparatus according to claim 1, further comprising:
an in-apparatus transmitter and receiver configured to transmit and receive the control information between the first processor and the second processor.

4. The optical transmission apparatus according to claim 1, further comprising:
an optical switch provided between the respective inter-apparatus transmitter and receivers for the first and second processors and the multiplexer and demultiplexer and configured to switch the control information optically communicated with the another optical transmission apparatus to either the first processor or the second processor, wherein
at least one of the first and second processors switches the optical switch so as to input and output the control information from and to the first processor or the second processor during control operation.

5. The optical transmission apparatus according to claim 2, wherein the first processor is configured to:
output the control information from the first processor to the different facing optical transmission apparatus via the inter-apparatus transmitter and receiver if the first processor is operating normally,
stop the inter-apparatus transmitter and receiver for the second processor from outputting the control information by notifying the second processor of normal operation of the first processor with the in-apparatus transmitter and receiver,
stop the inter-apparatus transmitter and receiver for the first processor from outputting the control information when the first processor stops, and
causes the inter-apparatus transmitter and receiver for the second processor to output the control information by notifying the second processor of stoppage of the first processor with the in-apparatus transmitter and receiver.

6. The optical transmission apparatus according to claim 4, wherein the first processor is configured to:
output, to the optical switch, a route instruction to input and output the control information between the first processor and the different facing optical transmission apparatus via the inter-apparatus transmission and reception unit if the first processor is operating normally, and
output, to the optical switch, a route instruction to input and output the control information between the second processor and the different facing optical transmission apparatus via the inter-apparatus transmitter and receiver if the first processor is in the stopped state.

7. The optical transmission apparatus according to claim 1, wherein
the main signal is a WDM signal into which a plurality of signals are wavelength-division-multiplexed,
the inter-apparatus transmitter and receiver transmits and receives the control information using an optical supervisory channel, and
the multiplexer and demultiplexer includes a coupler and a splitter configured to couple and split the control information into and from the WDM signal.

8. The optical transmission apparatus according to claim 1,
wherein the first processor and the second processor includes sets of first processors and second processors, the optical transmission apparatus inputs and outputs the control information from and to a facing upstream optical transmission apparatus using one of the sets of first processors and second processors and inputs and outputs the control information from and to a facing downstream optical transmission apparatus using another one of the sets of first processors and second processors.

9. The optical transmission apparatus according to claim 3,
wherein the first processor and the second processor includes a plurality of sets of first processors and second processors, the in-apparatus transmitter and receiver includes respective in-apparatus transmitter and receivers provided for the plurality of sets of first processors and second processors, and the optical transmission apparatus has a ring-shaped route inside and inputs and outputs the control information.

10. The optical transmission apparatus according to claim 3,
wherein the first processor and the second processor includes a plurality of sets of first processors and second processors, each of the sets of first processors and second processors serves as a hub, and the optical transmission apparatus has a route between ones of the hubs inside and inputs and outputs the control information under control of an in-apparatus signal path control unit.

11. An optical transmission system comprising:
a plurality of optical transmission apparatuses arranged on an optical transmission line and configured to transmit a main signal,
wherein at least one of the plurality of optical transmission apparatuses includes:
a first processor configured to perform alarm supervision and signal control of the optical transmission apparatus,
a second processor configured to perform the alarm supervision and the signal control of the optical transmission apparatus during a period when the first processor is in a stopped state,
inter-apparatus transmitter and receivers configured to transmit and receive a signal including control information for the alarm supervision between the first and second processors and another optical transmission apparatus facing the optical transmission apparatus, and
a multiplexer and demultiplexer configured to couple and split the signal for the main signal optically communicated with the another optical transmission apparatus,
wherein the plurality of optical transmission apparatuses output the control information to a network management apparatus via the optical transmission line.

12. The optical transmission apparatus according to claim 10,
wherein the optical transmission line includes an in-band supervisory control network.

13. An optical transmission method to be performed by a plurality of optical transmission apparatuses arranged on an optical transmission line and configured to transmit a main signal, the optical transmission method comprising:
performing, by a second processor, alarm supervision and signal control of one of the plurality of optical transmission apparatuses during a period when a first processor configured to perform the alarm supervision and the signal control of the one optical transmission apparatus is in a stopped state;
transmitting and receiving a signal including control information for the alarm supervision between the first and second processors and another optical transmission apparatus facing the one optical transmission apparatus; and
coupling and splitting the signal for the main signal optically communicated with the another optical transmission apparatus.
